(19) United States
(12) Patent Application Publication
(10) Pub. No.: US 2010/0269036 A1
(43) Pub. Date: Oct. 21, 2010

(54) SYSTEM AND METHOD FOR DESIGNING AND GENERATING ONLINE STATIONERY

(76) Inventors: Kelly D. Berger, Milpitas, CA (US); Jeffrey Michael marion, San Jose, CA (US); Xuyen Vuong, Fremont, CA (US); Mohammed Pedhiwala, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/426,810

(22) Filed: Apr. 20, 2009

(51) Int. Cl. G06F 17/20; G06F 3/048; G06F 17/30

(52) U.S. Cl. 715/243; 715/823; 715/856; 715/780; 715/269

(57) ABSTRACT

A computer-implemented method for designing an online stationery is described. One embodiment of the computer-implemented method comprises: defining a plurality of textboxes, each of the textboxes comprising text and/or variable codes, coordinate data defining textbox positioning, and a style class defining font, font size and/or font color; defining a layout comprising specific textboxes from the plurality of textboxes; defining a global template comprising one or more of the layouts; extracting metadata from a file or other content provided by a stationery designer; and generating a product template using information contained in the global template and the metadata extracted from the file.

### BACKGROUND

1. Field of the Invention

This invention relates generally to the field of data processing systems. More particularly, the invention relates to an improved architecture and method for designing and generating online stationery.

2. Description of the Related Art

Web-based systems for designing stationery such as wedding invitations, birth announcements, birthday party invitations, etc, are currently available over the Internet. As illustrated in FIG. 1, in current Web-based systems, a template designer 110 creates a static design template 120 for each type of stationery. The static design template 120 includes a plurality of text box regions 121, 122, 124 representing locations where text is to be displayed and potentially one or more image regions 124 representation locations where images uploaded by the user are to be displayed.

The static design template 120 is personalized via a Web-based user interface 130 made accessible to end users 111 over the Internet. The Web-based interface typically takes the form of a Web page which is downloaded to a client computer of the end user 111. The Web page includes a plurality of text entry fields 131, 132, 134 which correspond to the text box regions 121, 122, 124 within the design template, respectively. The Web page may also include one or more image entry fields 133 corresponding to the image regions 123 of the static design template 120. Images may be uploaded to the image entry field 133 and positioned within the image region 123 of the design template 120.

One problem with the current Web-based systems from a design perspective is that they lack flexibility. For example, a new static design template must be created in order to provide each new type of stationery (e.g., a new birth announcement, wedding invitation, etc). Moreover, from the user's perspective, current approaches do not provide guidance on appropriate text to enter into the text entry fields or how the text should be formatted. In addition, it is difficult to store the text entered by the user in one design and apply it to another design because the layout of the text and formatting in terms of font, color and size are different.

Accordingly, what is needed is an improved system for designing and generating online stationery.

### BRIEF DESCRIPTION OF THE DRAWINGS

A better understanding of the present invention can be obtained from the following detailed description in conjunction with the following drawings, in which:

FIG. 1 illustrates a prior art system architecture for generating online stationary.

FIG. 2 illustrates a system architecture according to one embodiment of the invention.

FIG. 3 illustrates a process according to one embodiment of the invention.

FIG. 4 illustrates one embodiment of the invention which supports template variable types including format options.

FIG. 5 illustrates one embodiment of the invention which supports variables.

FIGS. 6a-b illustrate a portion of an etiquette wizard employed in one embodiment of the invention.

FIGS. 7a-c illustrate another portion of a global template wizard employed in one embodiment of the invention.

FIGS. 8a-d illustrate a product template wizard according to one embodiment of the invention.

FIGS. 9a-d illustrate an exemplary series of Web pages employed in one embodiment of the invention.

FIGS. 10a-b illustrate an embodiment of the invention which uses template groups and layouts.

FIGS. 11a-c illustrate a layout wizard employed in one embodiment of the invention.

FIGS. 12a-c illustrate another layout wizard employed in one embodiment of the invention.

FIGS. 13a-f illustrate one embodiment of a product template wizard for creating a product template using template groups and layouts.

FIGS. 14a-e illustrate a series of Web pages for designing stationery according to one embodiment of the invention.

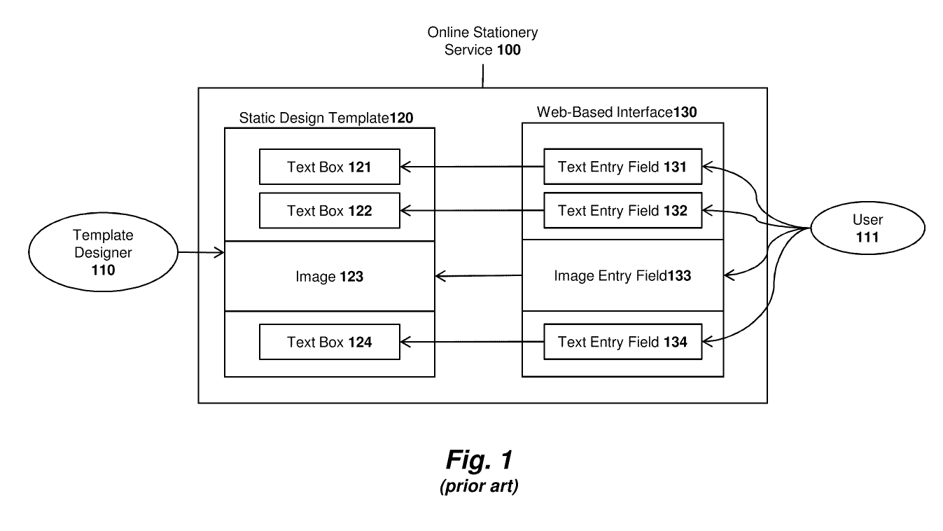

### DETAILED DESCRIPTION OF PREFERRED EMBODIMENTS

Described below is a system and method for designing and presenting online stationery. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

### An Exemplary Network Architecture

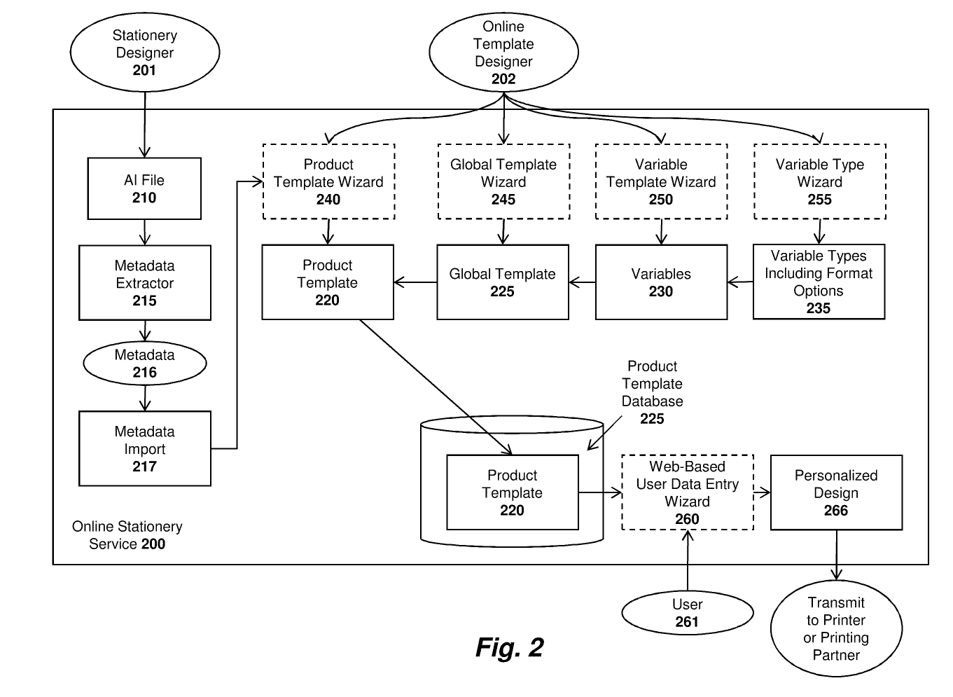

One embodiment of a system for generating stationery is illustrated in FIG. 2. The system provides support for two types of designers: stationery designers 201 who create new forms of stationery (e.g., new birth announcements, wedding invitations, etc), and online template designers 202 who create online templates using the designs provided by the stationery designers. The system includes a series of wizards 240, 245, 250, 255 to allow template designers 202 to efficiently design new product templates 220. In one embodiment, the wizards comprise software executed by a general purpose or special purpose processor. However, the underlying principles of the invention are not limited to a software implementation.

Each product template 220 embodies a unique stationery design such as a particular birth announcement or wedding invitation. Once completed, the product template 220 is stored within a product template database 225 and made accessible to end users 261 via a Web-based user data entry wizard 260. In one embodiment of the invention, the user data entry wizard 260 comprises a series of interrelated Web pages transmitted in succession to end users over the Internet. It should be noted, however, that the underlying principles of the invention are not limited to an Internet-based or Web-based implementation. After all of the required information has been collected from a user 261, a final, personalized design 266 containing the user-specific information is generated and sent to a printer or a printing partner over the Internet.

In one embodiment of the invention, a stationery designer 201 creates new stationery designs using an application such as Adobe® Illustrator® and uploads a file 210 containing the design to the online stationery service 200. In the example shown in FIG. 2, an Adobe Illustrator (AI) file 210 is used. It should be noted, however, that the underlying principles of the invention are not limited to any particular design format. A metadata extractor 215 executed on the online stationery service 200 extracts metadata 216 describing the new design in a non-proprietary, open format such as an Extensible Markup Language (XML) format. The metadata contains attributes for groups of text and graphics such as font, font size, leading, and coordinates. Metadata import logic 217 then parses the XML file, extracts the metadata and imports the metadata into the product template 220 (described in greater detail below).

FIG. 2 illustrates four different types of wizards employed in one embodiment of the invention: a variable type wizard 255 for creating new variable types 235, a variable template wizard 250 for creating new variables 230, a global template wizard 245 for creating global design templates 225, and a product template wizard 240 for creating product templates 220.

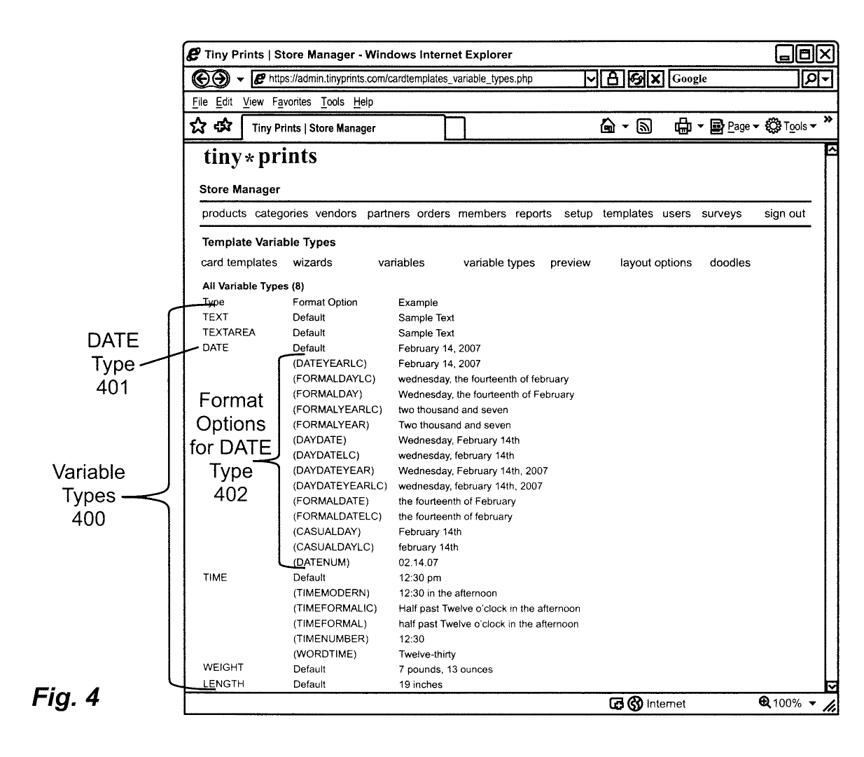

According to the embodiments of the invention described herein, the variable type wizard 255 allows template designers to create new variable types. The new variable types may then be stored and used in subsequent template designs. As illustrated in FIG. 4, in one embodiment, a plurality of format options 402 are specified for each variable type 400. For example, 14 different format options are specified for the variable type DATE including formal options (e.g., FORMALDAY), and casual options (e.g., CASUALDAY). Examples of how the date will be displayed on the stationery are provided for each format option. The format options may include the manner in which the text information is conveyed (e.g., “Wednesday, the fourteenth of February” for FORMALDAY) as well as text formatting options such as font type, font size and text highlighting (e.g., bold, italics, underline).

Once variable types and associated format options have been created, the variable template wizard 250 allows users to define variables for each new template. Each variable is assigned a particular variable type. Returning to the previous example, to include a “date” field within a design template, the template designer would create a variable of the variable type DATE and might also specify the particular format options to be used (e.g., FORMALDAY). The design process is streamlined in this manner because the format options are provided automatically upon selection of the variable type DATE. That is, the designer does not need to recreate the format options for the date because they are inherent in the DATE variable type.

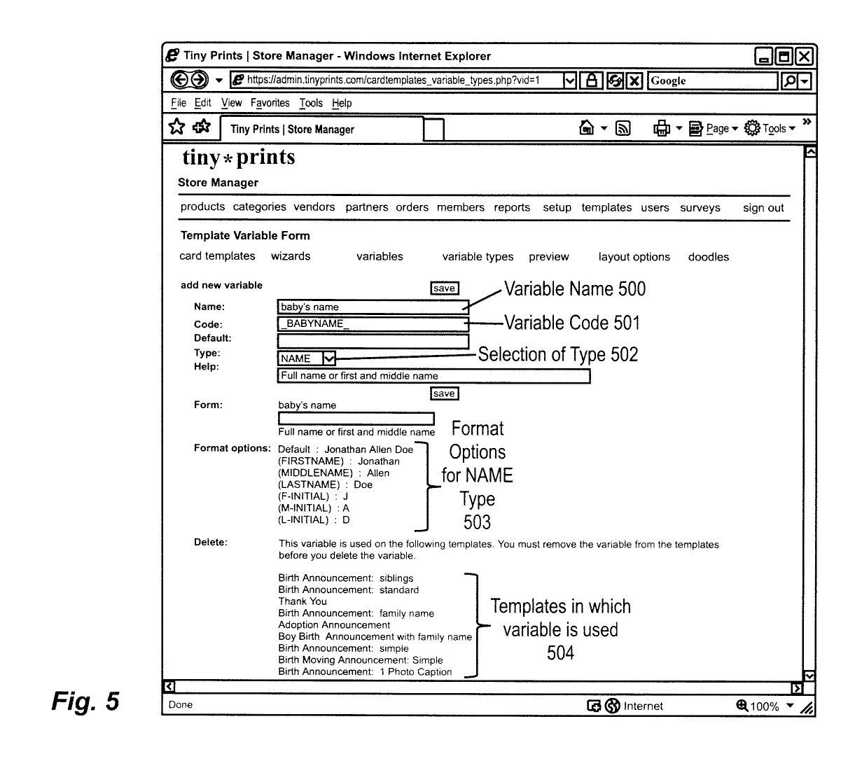

One embodiment of the variable template wizard 250, illustrated in FIG. 5, provides a field 500 for entering a new variable name (“baby's name”), a variable code 501 (“_BABYNAME_”), and a drop down menu 502 for linking the new variable to a particular variable type. In one embodiment, the drop down menu 502 provides a list of all variable types previously created and stored on the online stationery service 200. In the particular example illustrated in FIG. 5, the NAME variable type has been selected, and a plurality of format options 503 associated with the NAME variable type are displayed for the designer. In this case, the format options include those for names which are frequently used in stationery designs including First Name, Middle Name, Last Name, and First, Middle and Last initials.

Once variable types and variables have been defined, the global template wizard 245 is used for designing new global templates 225 and the product template wizard 240 is used for designing new product templates 220. Each product template 220 is unique, representing a completed stationery design offered to users. By contrast, each global template 225 may be reused in multiple different product templates. By way of example, a global template for a birth announcement contains the information typically required for any birth announcement (e.g., name, birth date, etc) and the product template contains information specific to a particular stationery design (e.g., image position, specific text location and formatting, etc).

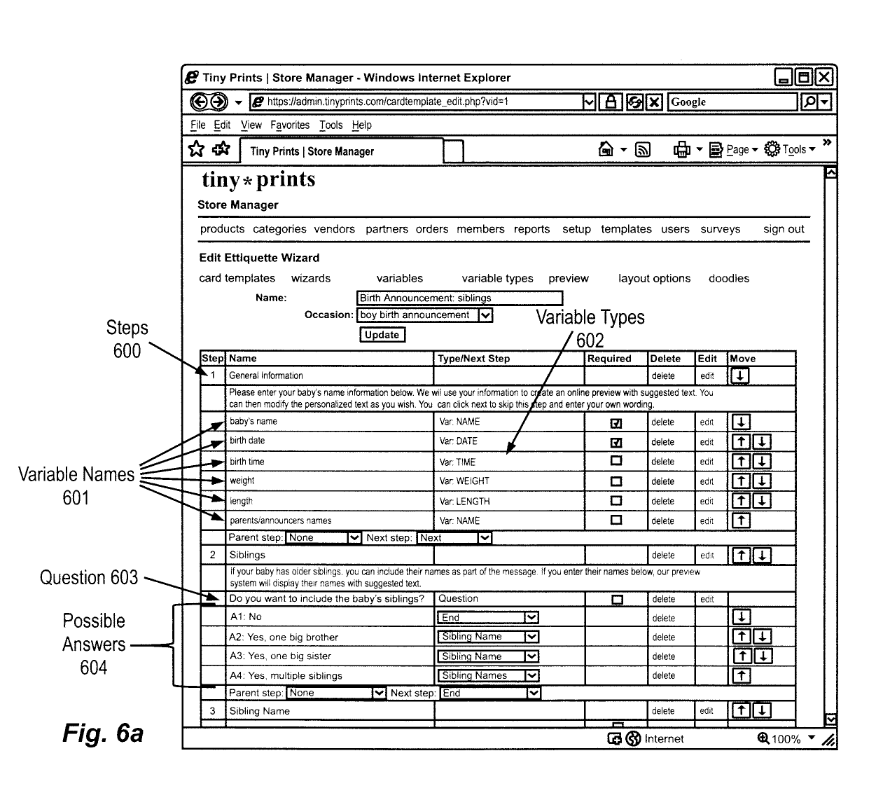

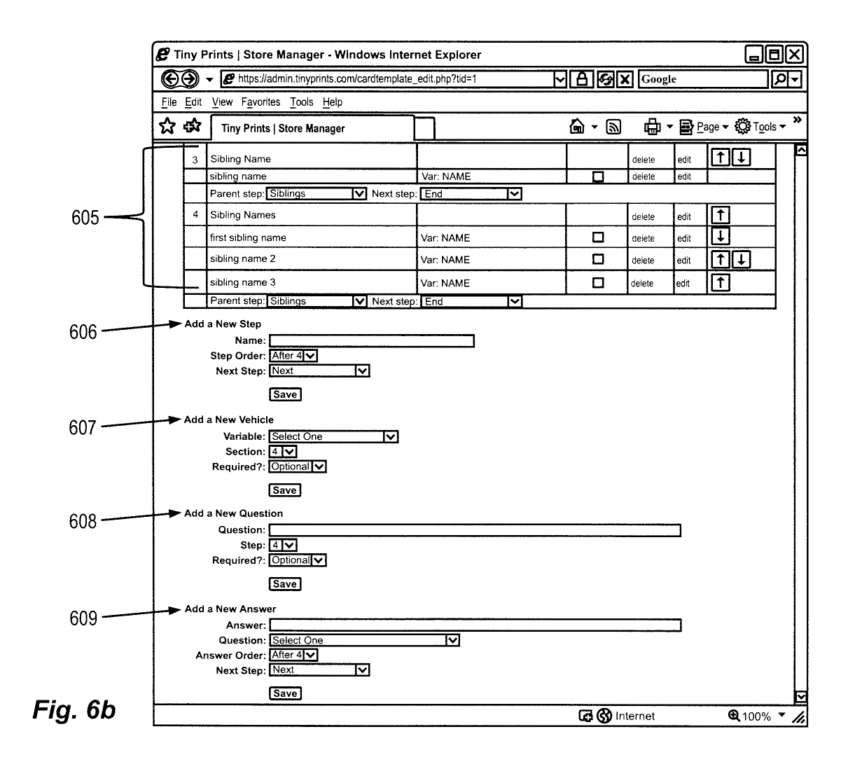

FIGS. 6a-b and 7a-c illustrate different components of an exemplary global template wizard for a birth announcement which includes information about siblings (named “Birth Announcement: siblings”). As illustrated in FIG. 6a (which shows the “Edit Etiquette Wizard”) the template designer creates a series of steps 600 to collect information from the end user. The first step (1) includes a series of variable names 601 which are ultimately mapped to data entry fields within the Web-based user data entry wizard 260. As mentioned above, each variable is assigned a specific variable type. For example, the variable “baby's name” is designated type NAME; “birth date” is designated type DATE; “birth time” is designated type TIME; “weight” is designated type WEIGHT; “length” is designated type LENGTH; and “parents/announcers” names is designated type NAME. As mentioned above, each variable type may specify a plurality of different formatting options such as text layout and appearance.

The second step includes a question: “Do you want to include the baby's siblings?” 603 followed by a series of possible answers 604. In response to one of the answers (“No”), no additional data entry is required. However, several of the answers correspond to new variables, as defined in steps 3 and 4 (see FIG. 6b). For example, step 3 specifies that the variable “sibling name” is type NAME and step 4 specifies three variables for multiple sibling names: “first sibling name,” “sibling name 2” and “sibling name 3,” each of which are type NAME.

Also shown in FIG. 6b is an option to add a new step to the global template 606, an option to add a new variable 607, an option to add a new question 608, and an option to add a new answer 609. As illustrated, the template designer may specify the order in which the new steps and answers will appear within the Web-based user data entry wizard 260 and may designate variables and questions as either “required” (i.e., the user must enter a value) or “optional.” If a variable or question within a global template 225 is optional, then the user may proceed to the next step with or without entering a value. As illustrated in FIGS. 6a-b, check boxes are provided for each variable and question to indicate whether the variable/question is required or optional. Options are also provided to delete or edit existing questions or variables and to move the question or variable up or down within a step.

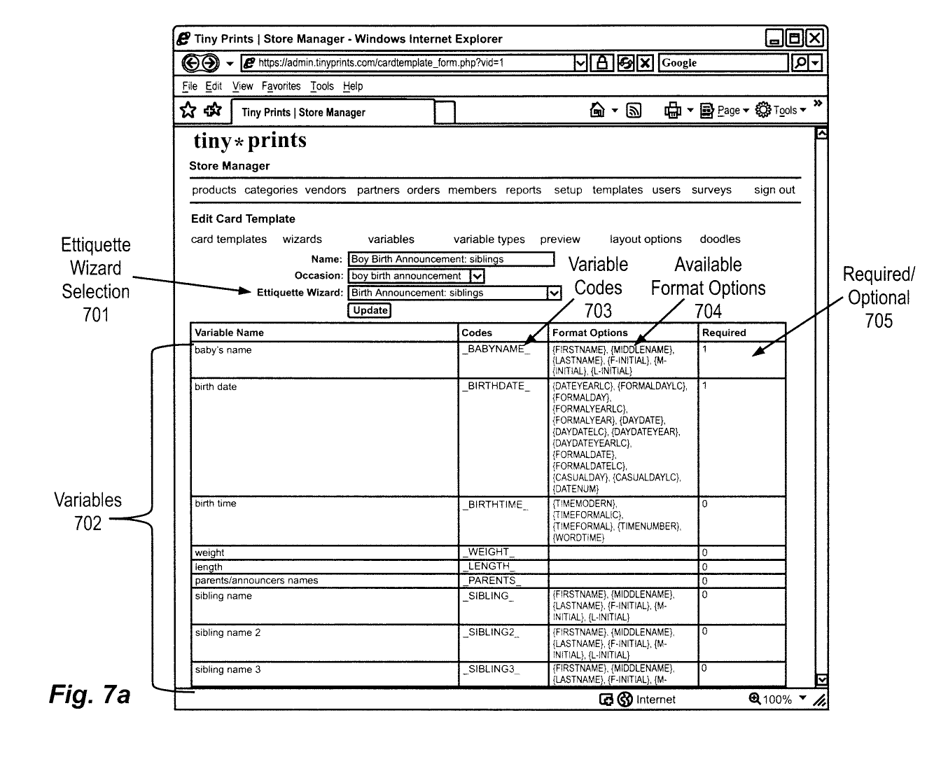

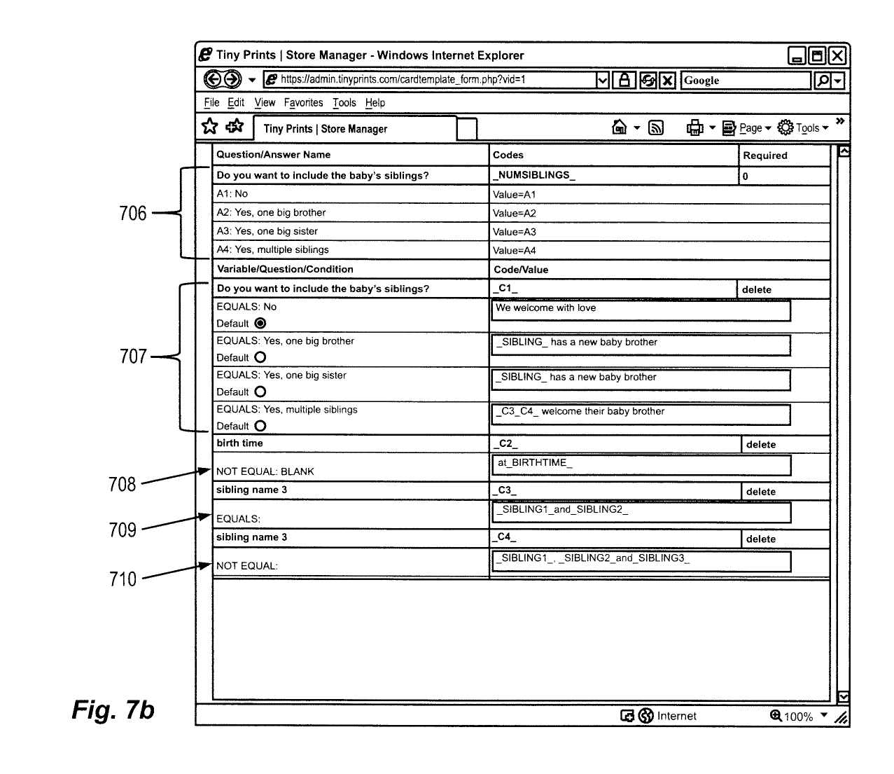

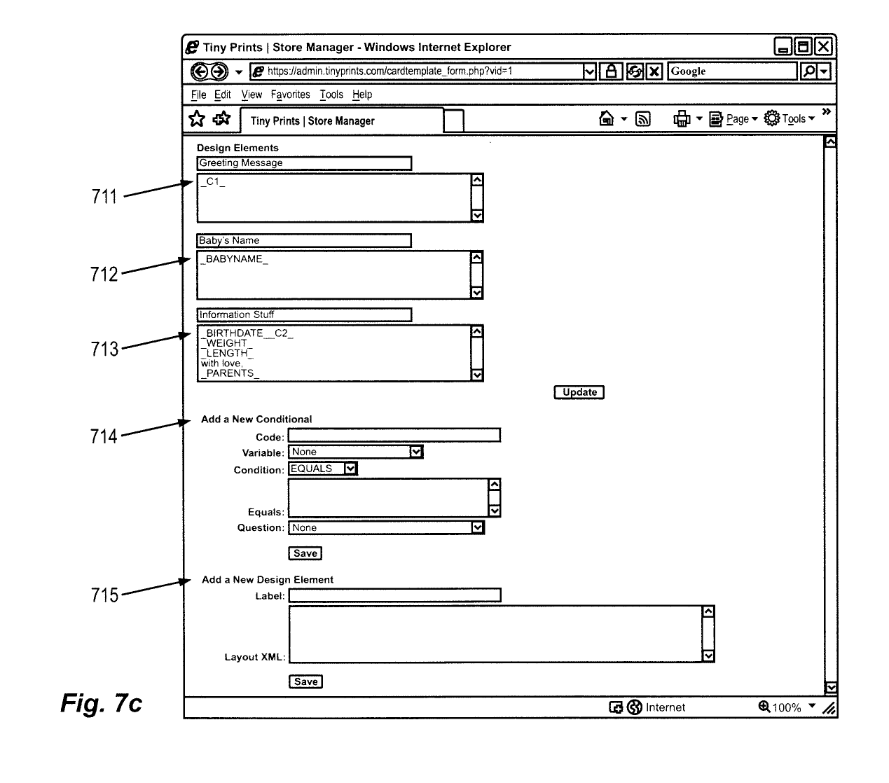

FIGS. 7a-c illustrate a second component of the global template wizard which performs conditional operations on the data entered by the user via the Etiquette Wizard (FIGS. 6a-b). After specifying a name and occasion for the global card template, a drop down menu 701 is provided to specify the Etiquette Wizard to be used for the global card template. In this case, the “Birth Announcement: siblings” template illustrated in FIGS. 6a-b has been selected. Consequently, the variables 702 from the global template are imported into the global template along with corresponding codes 703, formatting options 704 (i.e., as specified by the designated variable type) and an indication as to whether the variable is required or optional 705.

As illustrated in FIG. 7b, questions and answers are also imported from the etiquette wizard into the global card template. In region 706, the variable identified by the code _NUMSIBLINGS_is set based on answers provided by the end user. For example, if the answer to the question “Do you want to include the baby's siblings?” is “Yes, one big brother,” then the variable _NUMSIBLINGS_ is set to the answer. In region 707, the text to be displayed in response to the answer is defined. For example, in response to the answer “Yes, one big brother” the code value _C1_ is set to “_SIBLING_ has a new baby brother” where _C1_ is a string displayed within the template design and —SIBLING_ is the name of the new baby's brother. As shown in FIG. 7c, the product template wizard provides a “design elements” section comprised of fields in which codes specified in FIG. 7b are specified. In this case, the code “_C1_” results in the text “_SIBLING_ has a new baby brother” displayed on the final design template (where _SIBLING_ is the name of the baby's sibling).

Additional variables C2, C3 and C4 are set as shown within regions 708, 709 and 710, respectively, in FIG. 7b. The variable C2 is set to “at _BIRTHTIME_” where “_BIRTHTIME_” is the time of birth entered by the end user and variables C3 and C4 are used if more than one sibling name is required.

As shown in FIG. 7c, the end result is _C1_ (“_SIBLING_ has a new baby brother” in the illustrated example) followed by the baby's name (_BABYNAME_) as indicated at 712; the birth date followed by the birth time (_BIRTHDATE__C2_); the baby's weight (_WEIGHT_); length (_LENGTH_) and a message “with love _PARENTS_” where “_PARENTS_” represents a variable set to the names of the parents. Options are also provided to add a new conditional variable (714) or a new design element (715).

Returning to FIG. 2, in one embodiment of the invention, the product template wizard combines the metadata 216 extracted from the AI file 210 by metadata import logic 217 with the data entered by the online template designer 202 to create a new product template. The metadata 216 extracted from the AI file 210 comprises layout information describing where text and graphical elements should be positioned within the product template 220 (i.e., coordinate data), and data describing each text box and graphical element within the AI file. Returning to the above example, the metadata 216 provides coordinates for the location of the phrase “_SIBLING_ has a new baby brother” in the final product template 220. Similarly, the metadata 216 specifies the coordinates for any photographs used in the product template 220 and/or formatting information such as font, color and alignment of the text and graphics.

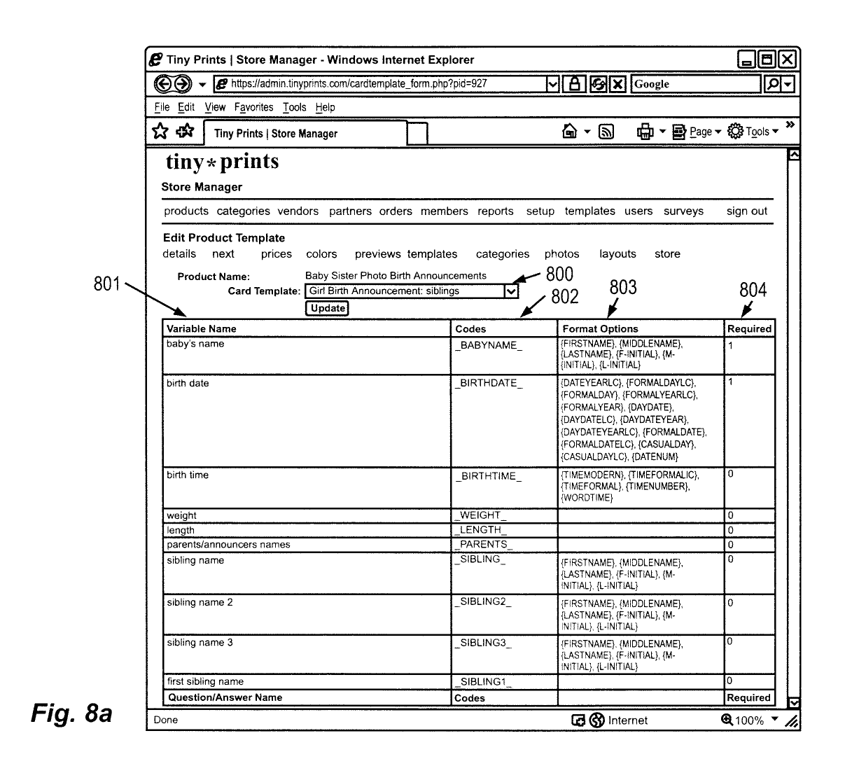

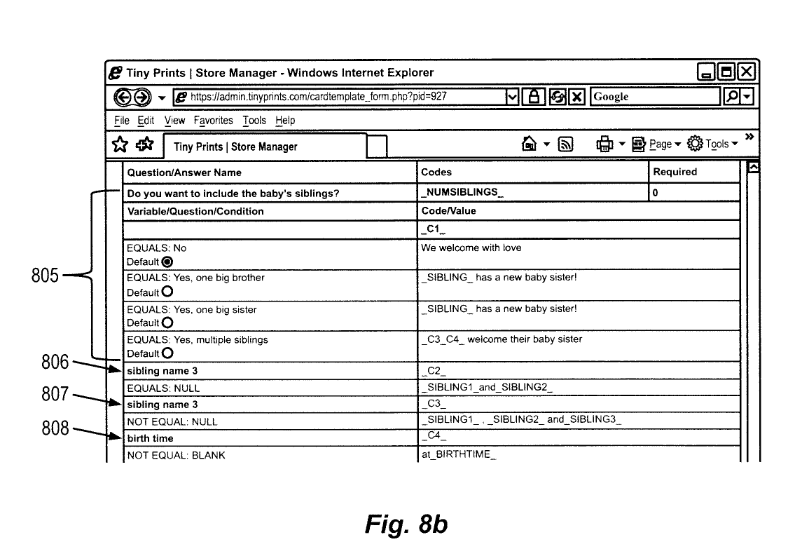

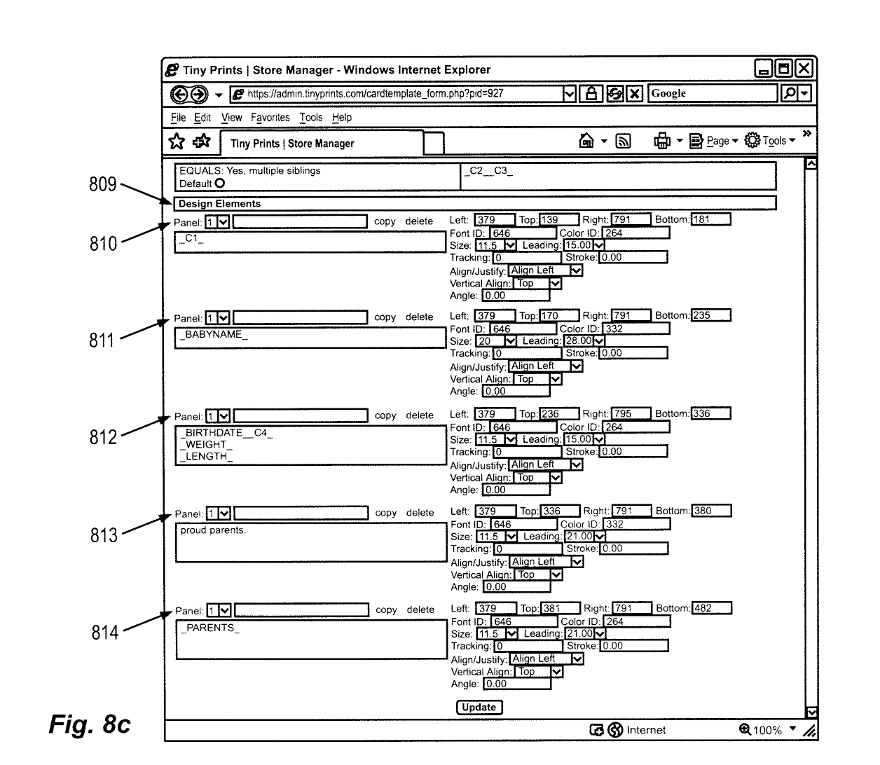

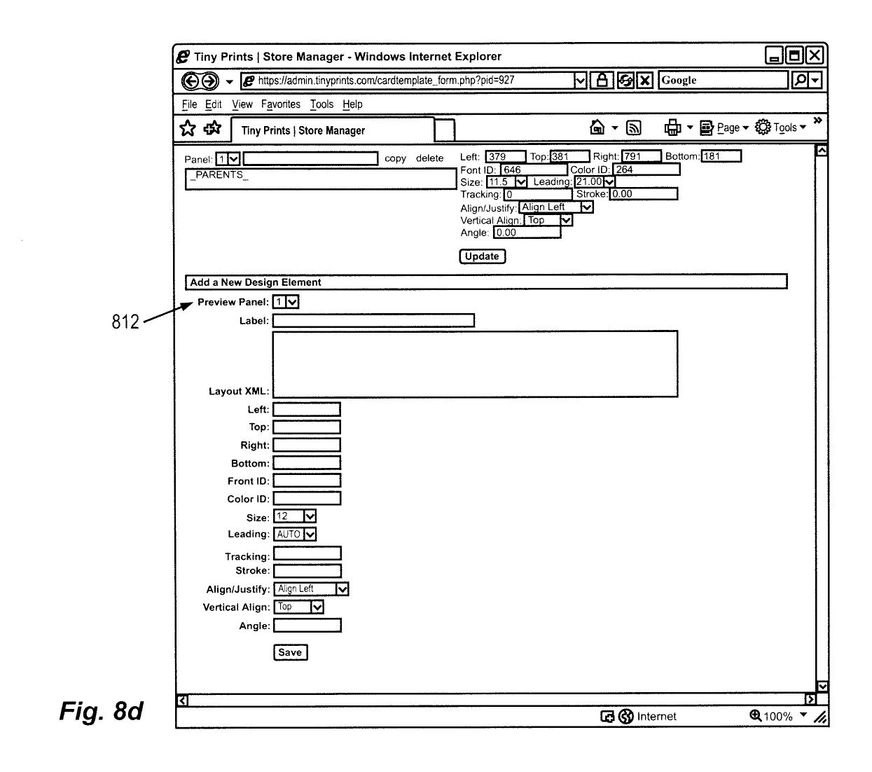

An exemplary product template wizard 240 is illustrated in FIGS. 8a-d. The template designer 202 specifies a global template to be used for the product template via a drop down menu 800. In this case, a global template for a girl birth announcement with siblings has been selected. A listing of all of the variables used in the product template are provided directly beneath the drop down menu. Separate columns are provided for the variable names 801, variable codes 802, format options 803, and an indication as to whether the variables are required 804.

As illustrated in FIG. 8b, questions and answers are also imported from the etiquette wizard into the product template. In region 706, the variable identified by the code _NUMSIBLINGS_ is set and the text to be displayed in response to user input is defined. For example, in response to the answer “Yes, one big brother” the code value _C1_ is set to “_SIBLING_ has a new baby sister” where _C1_ is a string displayed within the template design and SIBLING_ is the name of the new baby's brother. Other codes illustrated in FIG. 8b include _C2_ for two siblings, _C3_ for three siblings, and _C4_ for birth time.

As shown in FIG. 8c, the product template wizard provides a “design elements” section 809 comprised of fields in which the codes evaluated in FIG. 8b are displayed. In this case, the code _C1_ 810 results in the text “_SIBLING_has a new baby sister” displayed on the final product template (where _SIBLING_ is the name of the baby's sibling). Additional codes and text integrated within design elements in FIG. 8c include the baby's name 811, birth date, weight, length 812, the text “proud parents” 813 and a code (_PARENTS_) for the parents names 814.

Each individual design element 810-814 includes information imported from the AI file 210 to define the positioning and look & feel of the product template. In the example shown in FIG. 8c, the information for each design element includes the coordinates of the text box in which the text of the design element should be positioned (as defined by left, top, right and bottom values), the font, the color, the size, the leading, tracking number, stroke, alignment information (e.g., left, right, justified), vertical alignment (e.g., top, bottom, center), and the angle at which the design element should be positioned. Using the product template wizard shown in FIG. 8c, the template designer adjusts any of the variables and/or text for each design element. Moreover, although not illustrated in FIG. 8c, separate design elements for images may be provided within the product template.

As illustrated in FIG. 8d, a design region 812 is provided to allow the template designer to specify one or more additional design elements. As shown, separate data entry fields are provided for each of the coordinate, text and other layout information described above (e.g., coordinates, fonts, text, color, etc). Once the information is input into the system, the template designer selects a “save” button to update the product template.

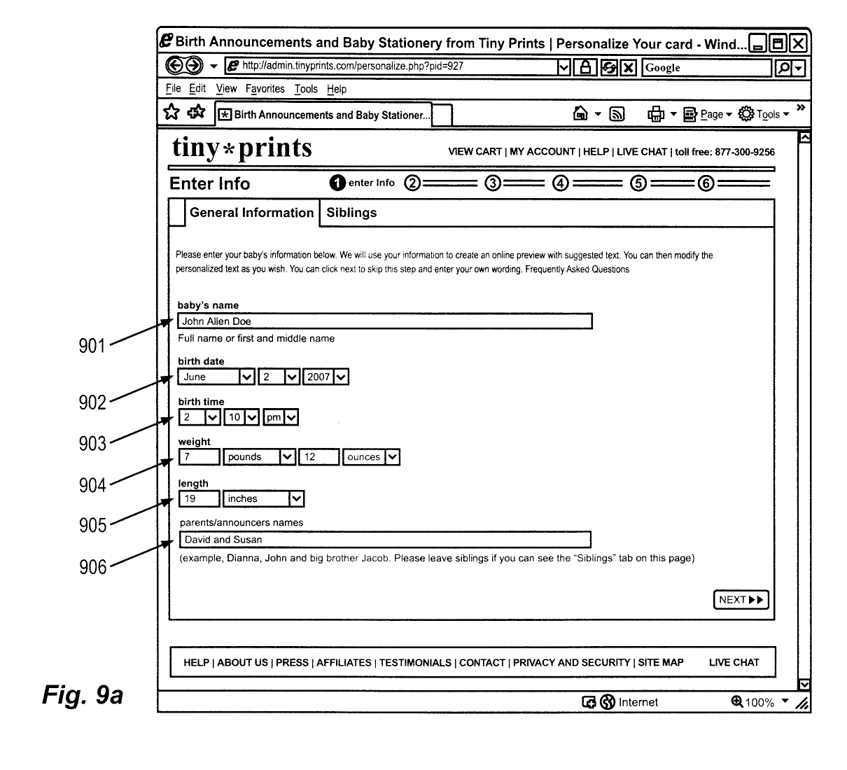

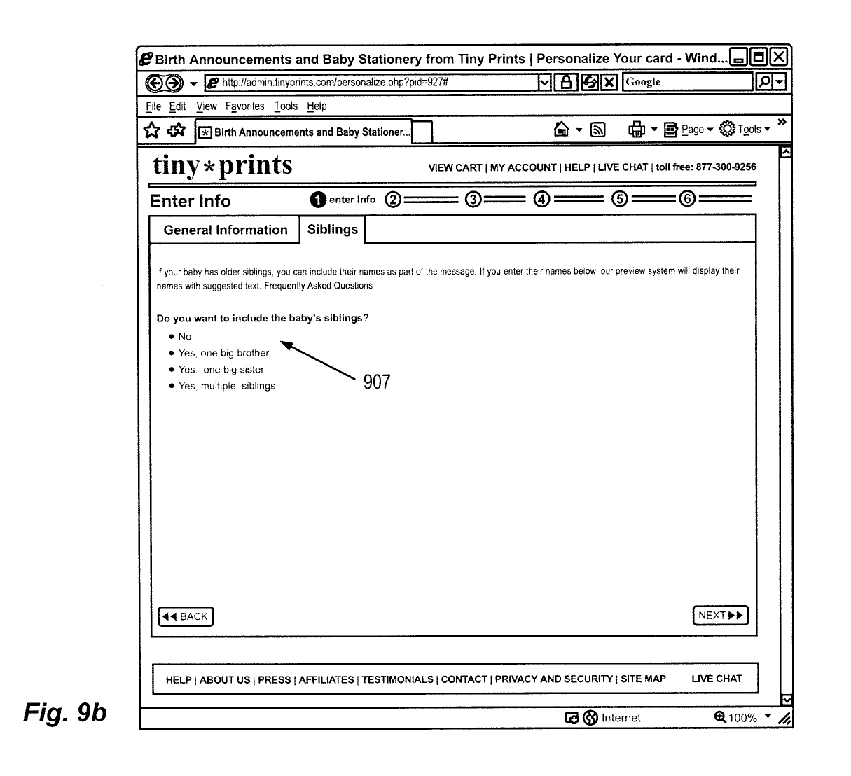

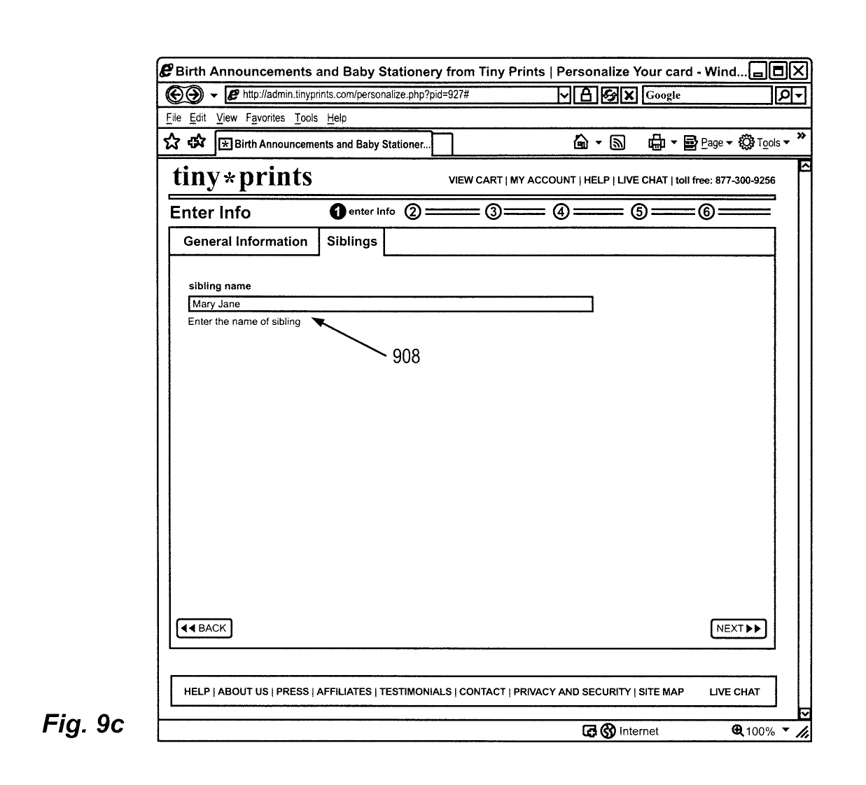

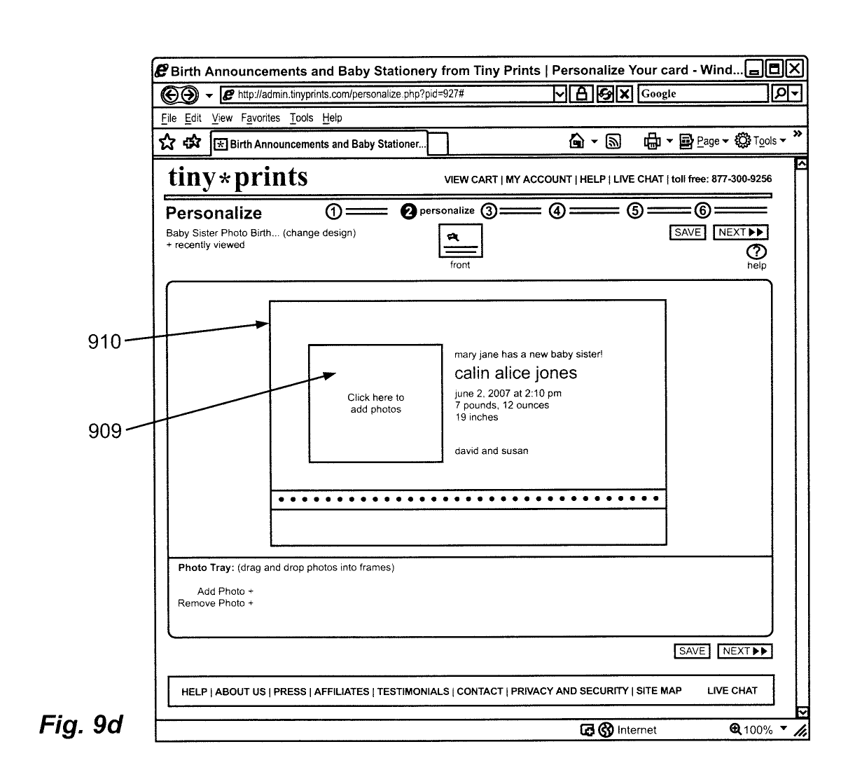

After the product template 220 is created, the Web-based user data entry wizard 260 requests the information needed to complete the personalized stationery design 266. In one embodiment, the Web-based user data entry wizard 260 transmits one or more Web pages containing questions and data entry fields, as specified by the product template (e.g., “Do you want to include the baby's siblings” as shown in FIG. 7b). An exemplary series of Web pages are illustrated in FIGS. 9a-d. FIG. 9a illustrates a plurality of data entry fields 901-906 into which the user enters information specified by the product template (e.g., baby's name 901, birth date 902, birth time 903, weight 904, length 905, and parents' names 906). FIG. 9b illustrates a question 907 (“Do you want to include the baby's siblings?”). As mentioned above, the product template performs a conditional analysis of the answer to the question to generate the personalized template design. Based on the answer to the question, another one or more data entry fields 908 may be provided as illustrated in FIG. 9c (in this case, the names of the siblings). FIG. 9d illustrates a preview of the personalized product template and a region 909 into which the user may add a photo. After the user enters the requested information, a personalized stationery design 266 is generated and transmitted to a printer or a printing partner over the network. In one embodiment, the personalized design 266 is generated in the form of a PDF file. It should be noted, however, that the underlying principles of the invention are not limited to any particular personalized design format.

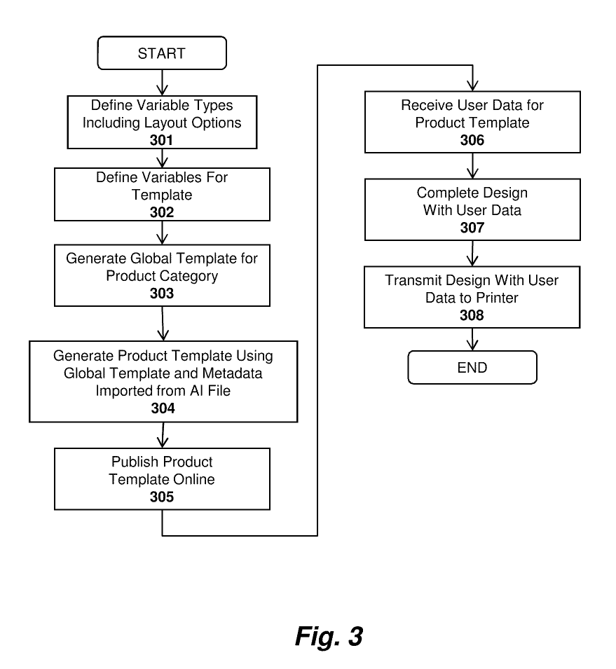

A method outlining the foregoing process is illustrated in FIG. 3. At 301 the template designer defines variable types including formatting options and at 302 the template designer specifies variables to be used for the template. At 303, the template designer creates the global template for the product category (e.g., boy birth announcement). At 304, the template designer creates the product template using information contained in the global template and the metadata extracted from the AI file (or other file type). At 305 the product template is published online. For example, an image of the stationery containing the design may be displayed on a Website and made accessible to end users. At 306, the user enters the data required to personalize the stationery such as names, dates, locations, and pictures. At 307, a personalized design is created with the user data and, at 308, the personalized design is sent to a printer and/or printing partner over a network.

### Embodiments Using Template Groups and Layouts

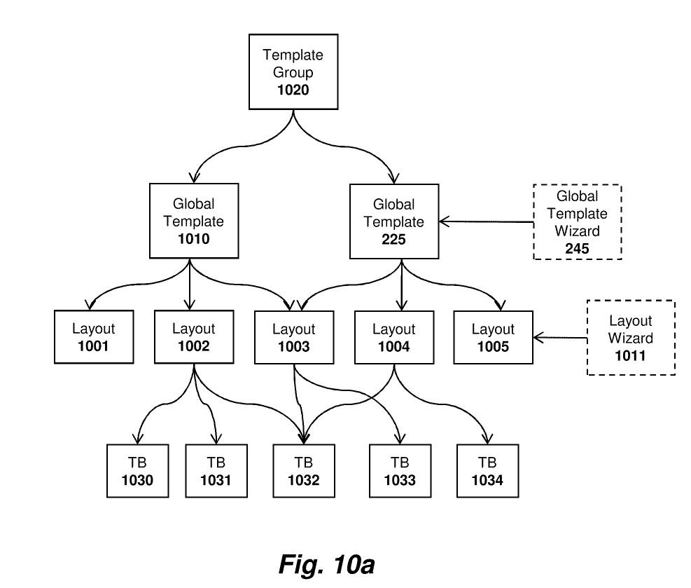

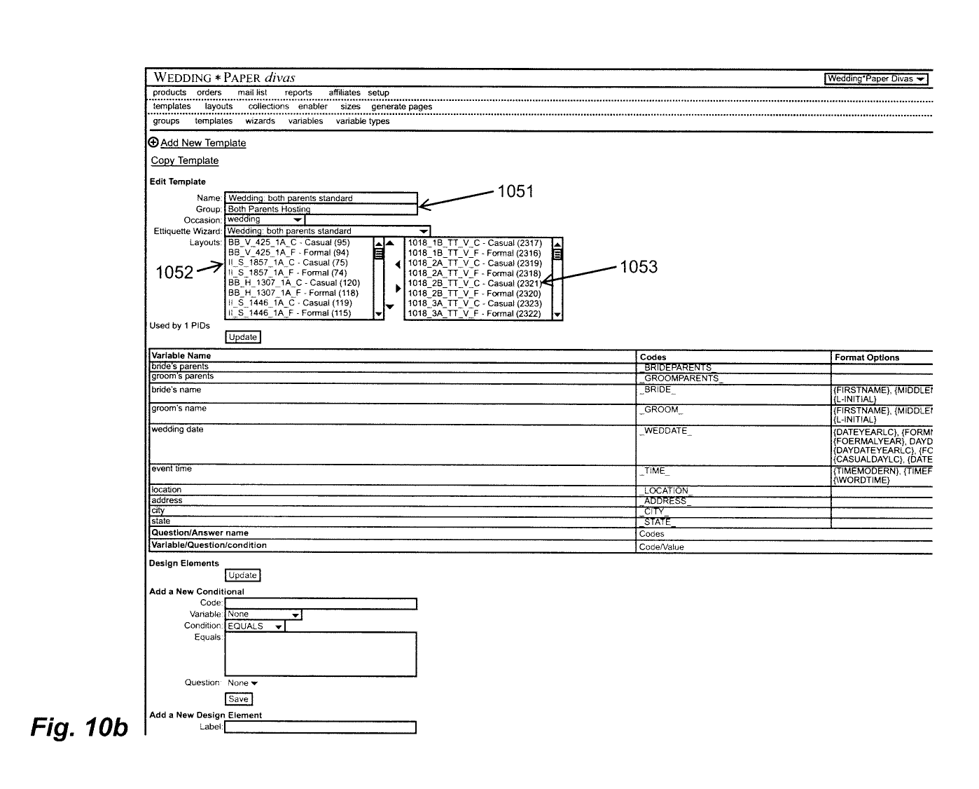

As illustrated in FIG. 10a, in one embodiment of the invention, related global templates are combined together into template groups 1010, 225; each global template 1010, 225 is comprised of one or more layouts 1001-1005; and each layout is comprised of one or more textboxes 1030-1034. These features are described in detail below. In this embodiment, a layout wizard 1011 (described below) is used to create and edit each of the different layouts 1001-1005.

Once a layout has been created it may be utilized by multiple global templates. For example, in FIG. 10a, layout 1003 is used by global template 225 and global template 1010. Similarly, textbox is 1032 used by three different layouts 1002-1004. This separation of logical components provides a more flexible and scalable architecture than prior embodiments. For example, system components in this embodiment are more modular and can be re-used more easily than in prior embodiments.

FIG. 10b illustrates a new embodiment of the global template wizard 245 which implements the above features. As in prior embodiments, the global template editor shown in FIG. 10b performs conditional operations on the data entered by the user via the Etiquette Wizard (see FIGS. 6a-b). In addition, the global template editor shown in FIG. 10b allows the designer to associate the template with a template group 1051. Template groups are used to logically link templates sharing similar characteristics. In this case, the template “Wedding: both parents standard” is grouped into template group “Both Parents Hosting.” Various other templates in which both parents are hosting the wedding may also be grouped within the same “Both Parents Hosting” template group to simplify organization and make it easier for relevant templates to be identified for each product template 220.

In addition, the global template editor shown in FIG. 10b allows the designer to specify one or more layout options for the template. As illustrated, a listing of all available layouts 1053 and a listing of selected layouts 1052 is provided. When a designer selects a layout from the list of all available layouts 1053 (e.g., via a mouse or other cursor control device), the selected layout is moved into the listing of selected layouts 1052 for the template. As described in greater detail below, layouts are comprised of a series of text boxes, each containing coordinate data (indicating where the text box is positioned) and style data (indicating a particular style to be used). Thus, in one embodiment, the layout information replaces the information contained in the design elements section 809 used in prior embodiments (see, e.g., FIG. 8c). Once again, the separation of layout information from templates provides a more modular and scalable architecture than in prior embodiments.

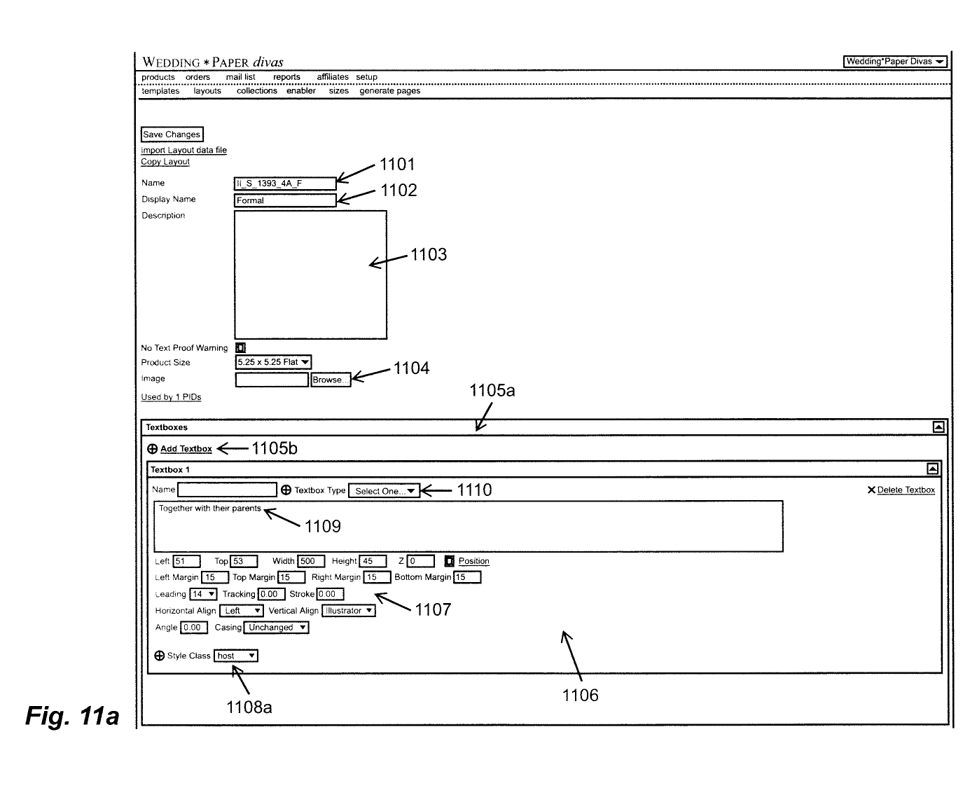

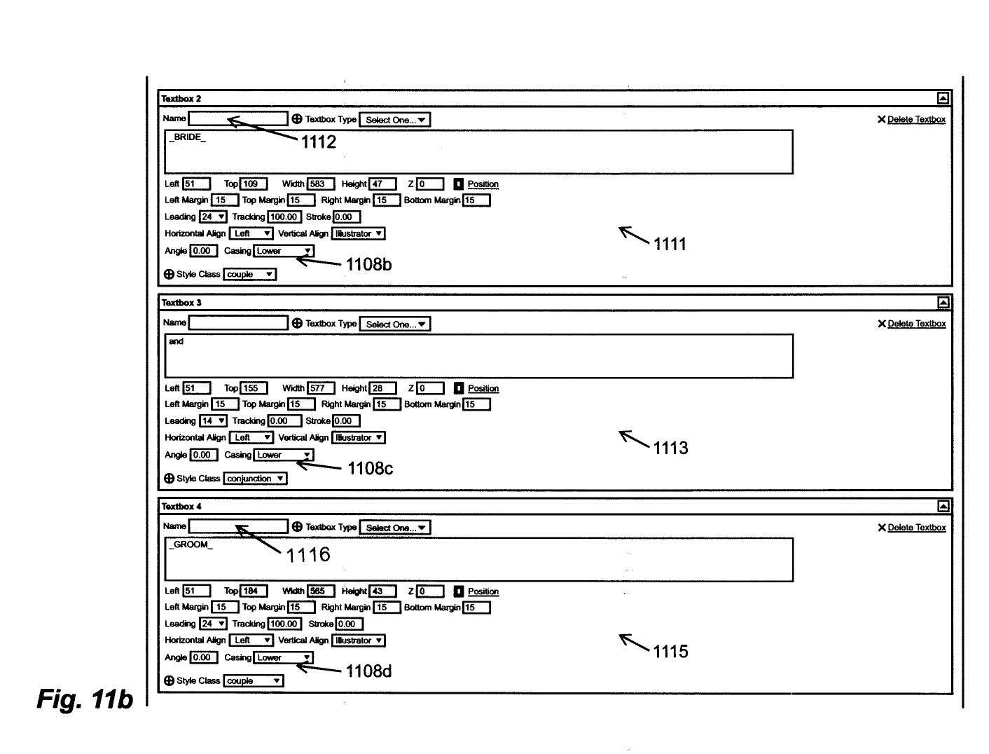

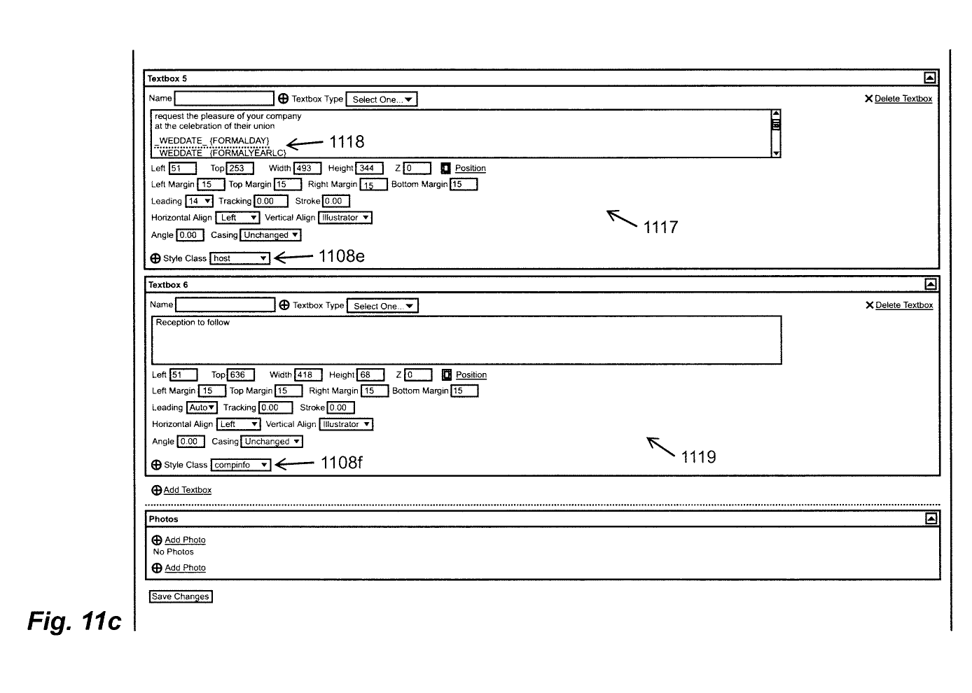

One embodiment of a layout wizard 1011 for constructing a layout is illustrated in FIGS. 11a-c. A name 1101 in the form of a text string is entered to identify the layout. In addition, a display name 1102 is entered to identify the layout to the end user within a stationery design Web page (as described below). In this example, the name is comprised of a series of internal codes used by designers and the display name, “Formal,” is used to indicate to the end user that the layout is a “formal” type of layout. The layout wizard 1011 also includes a description field 1103 in which a description of the layout may be entered and an image field 1104 for specifying a thumbnail image to be used to represent the layout in the end user interface.

A textboxes region 1105a is provided to display one or more textboxes for the layout. New textboxes may be added via selection of an “Add Textbox” link 1105b. A single textbox 1106 is illustrated in FIG. 11a and additional textboxes 1111, 1113, 1115, 1117, and 1119 included in the layout are illustrated in FIGS. 11b-c. As illustrated in FIG. 11a, each textbox includes a textbox type selection 1110. As with variable types (described above), different textbox types may be designed and used to specify certain characteristics of the text that will be contained in each textbox. Textbox types are created by template designers to group several versions of suggested text that can then be provided as options to the template designer when creating layouts and to the end user when creating a personalized product. This is another mechanism to separate logical components and provides a more flexible and scalable architecture than prior embodiments.

Each textbox also includes a region 1109 for specifying a portion of the text to be used in the product template. In addition to standard text, variable codes containing text entered by the end user may be used within the text regions. For example, in FIG. 11b, variable code “_BRIDE_” 1112 comprises the name of the bride and variable code “_GROOM_” 1116 comprises the name of the groom (i.e., after this information has been entered by the end user via a Web page). Similarly, in FIG. 11c, different variable codes 1118 are used to display the day and the year of the wedding according to a specified display format (e.g., formal, casual, etc).

Each textbox also includes a set of coordinates and alignment data 1107 which indicate the position of the textbox within the layout. The data includes the coordinates of the left and top borders of the textbox; the width and height; a Z value (for specifying a 3-dimensional coordinate, if needed); left, right, top and bottom margins; leading; tracking; stroke; horizontal alignment; vertical alignment; rotation angle; and casing. Leading defines the amount of vertical space between lines of text. Tracking defines the amount of space between two letters in a line of text. Stroke defines the thickness of the outlines of the text. Horizontal alignment is left to right alignment of the text within the text box such as left, center, right and full justify. Vertical alignment defines whether the text should align at the top, bottom or center of the text box. Rotation angle defines the degree of rotation of the text box with 0.0 horizontal and 90 being vertical with text direction going up. Casing defines the default text casing such as upper case, lower case, upper casing of each word, or upper casing of the first word in a line of text.

In addition, a style class 1108 is specified for each textbox. In one embodiment, a style class specifies the default font, font size, and font style (e.g., normal, italic, bold, all caps, small caps, etc) to be used for the displayed text within the product template. In the example shown in FIGS. 11a-c, “host” style classes 1108a and 1108e have been selected for textboxes 1106 and 1117, respectively; “couple” style classes 1108b and 1108d have been selected for textboxes 1111 and 1115, respectively; a “conjunction” style class 1108c has been selected for textbox 1113; and a “compinfo” style class 1108f has been selected for textbox 1119. As described below, in addition to providing default style, each style class may also provide a range of modifiable options for that style (e.g., a range of font sizes and colors). These options may then be specified by the user during the stationery design process, as described below.

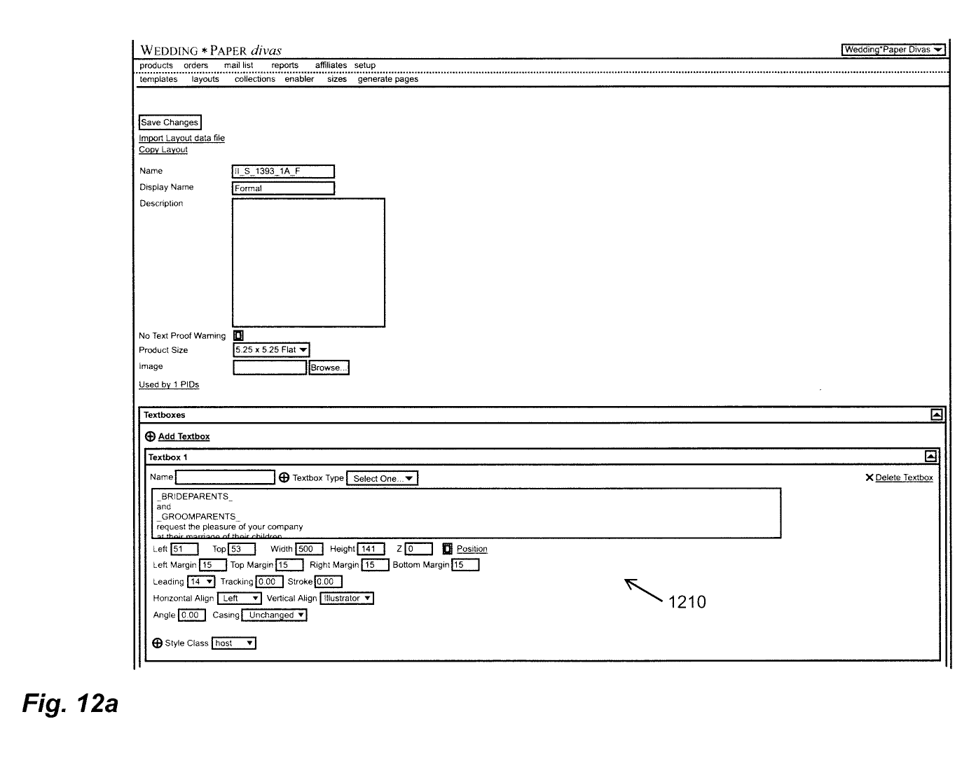

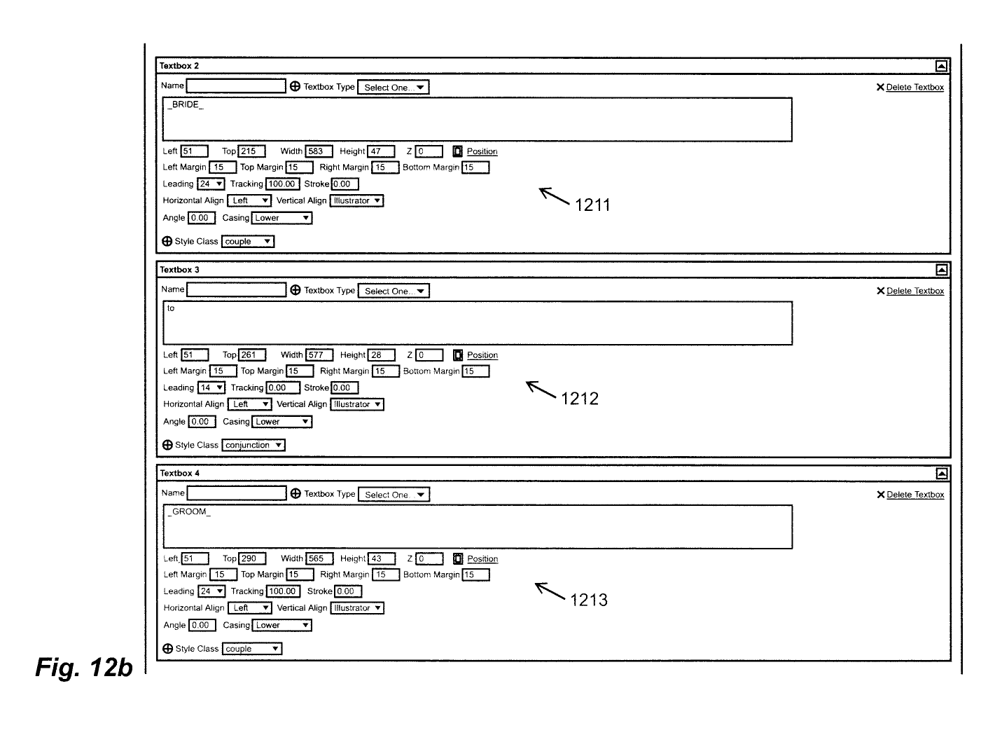

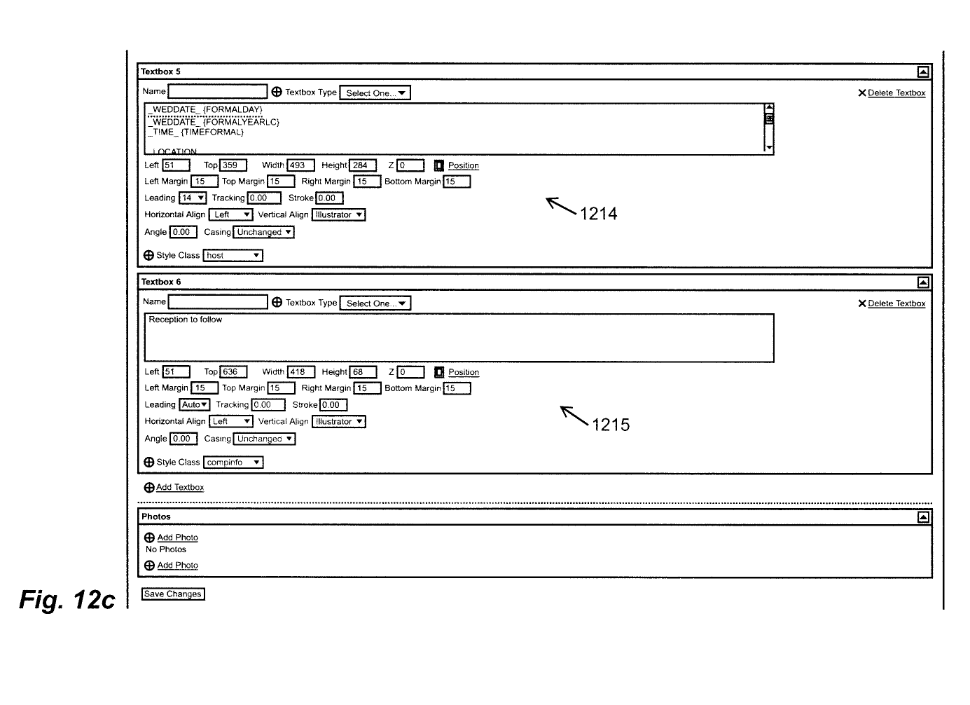

For the sake of comparison, a different layout comprised of a different set of textboxes 1210-1215 is illustrated in FIG. 12a-c. As described below, both of these layouts (and others) may be associated with a single global/product template and made available as options to the end user during the stationery design process.

In one embodiment, to further simplify the template design process, each layout defines the number of textboxes and their relative position while the final positioning of each text box is dynamically generated for each product when the corresponding layout is selected in the product template. In this embodiment, product setup data associated with the product template includes a definition of a “personalization area” within the stationery design where text boxes can be positioned. When the end user enters personalization information and selects a template and layout, the product template wizard 240 dynamically calculates the position of each text box in the layout based on the size and position of the personalization area, the number of text boxes used in the layout, the number of lines of text in each text box, and the attributes of the text that determines the size of the text including font, size, leading, and tracking. For example, in one embodiment, the product template wizard 240 attempts to space the textboxes evenly within the personalization area.

FIG. 12d illustrates an example in which the area outside the black rectangles 1250 comprises the personalization area 1251. Thus, in this embodiment, the area 1250 which is not used for personalization is specified using rectangular coordinates. In another embodiment, the personalization area 1251 is itself specified using rectangular coordinates. The underlying principles of the invention are not limited to the specific manner in which the personalization area is specified. FIG. 12e illustrates the layout with three text boxes 1260-1262 incorporated into the personalization area in FIG. 12d. When this layout is applied to the product with this personalization area and right alignment, the text in the text boxes is displayed only in the personalization area, as illustrated.

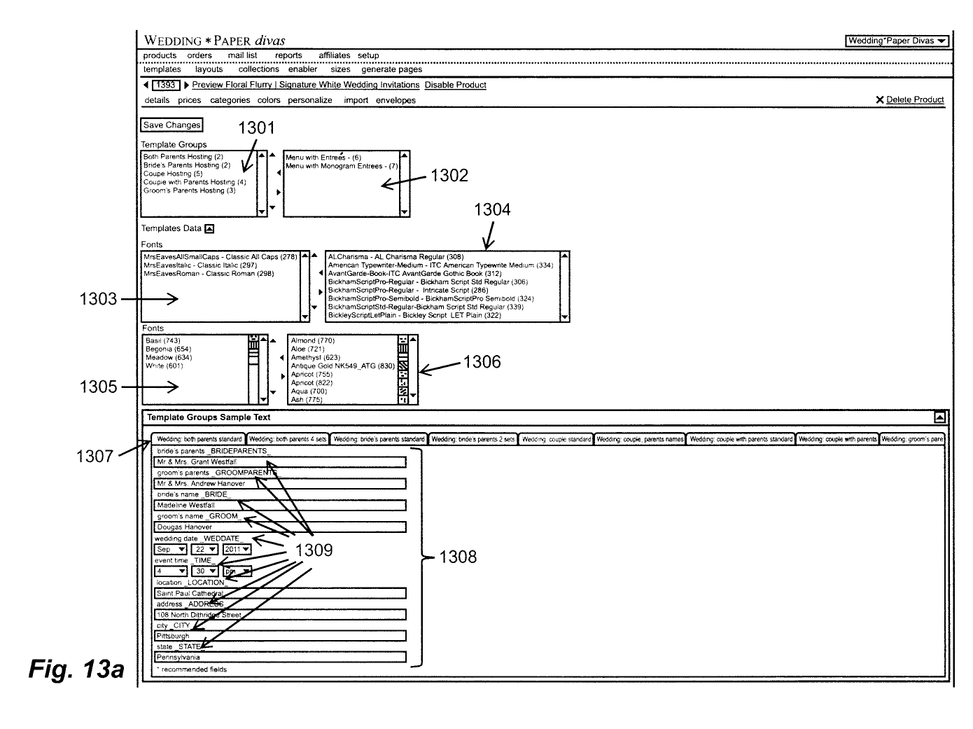

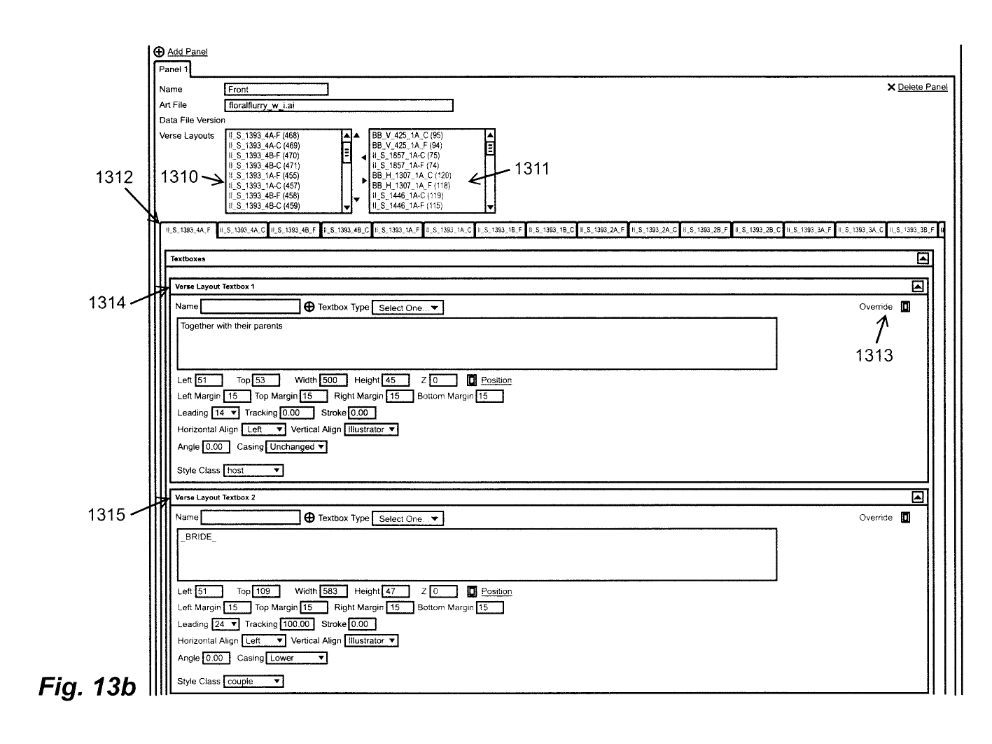

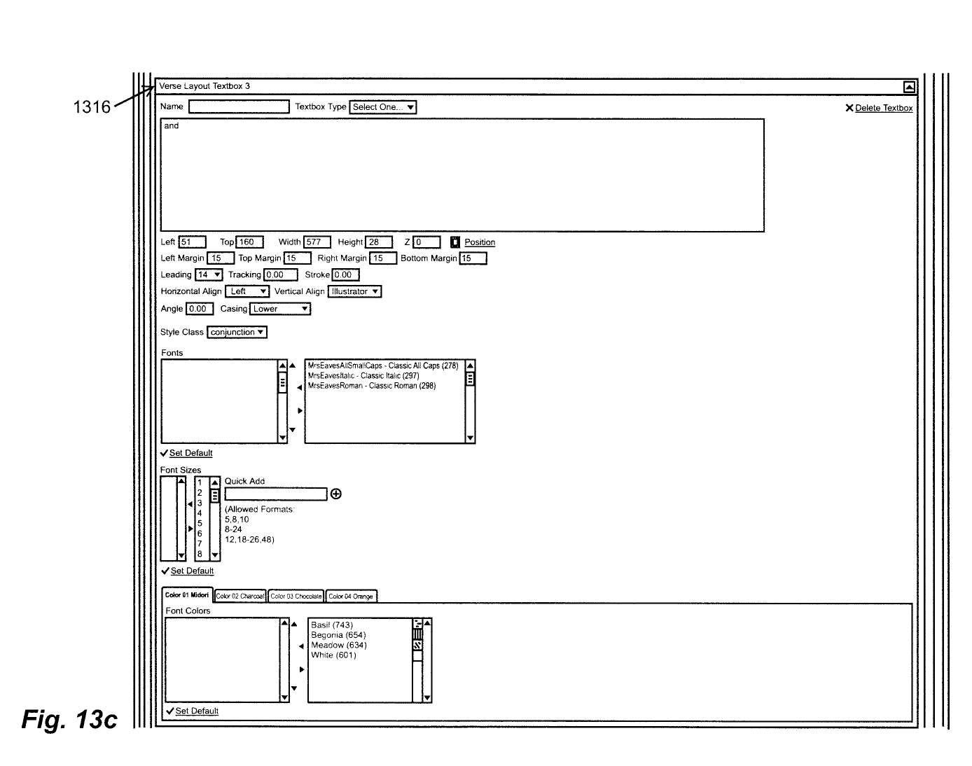

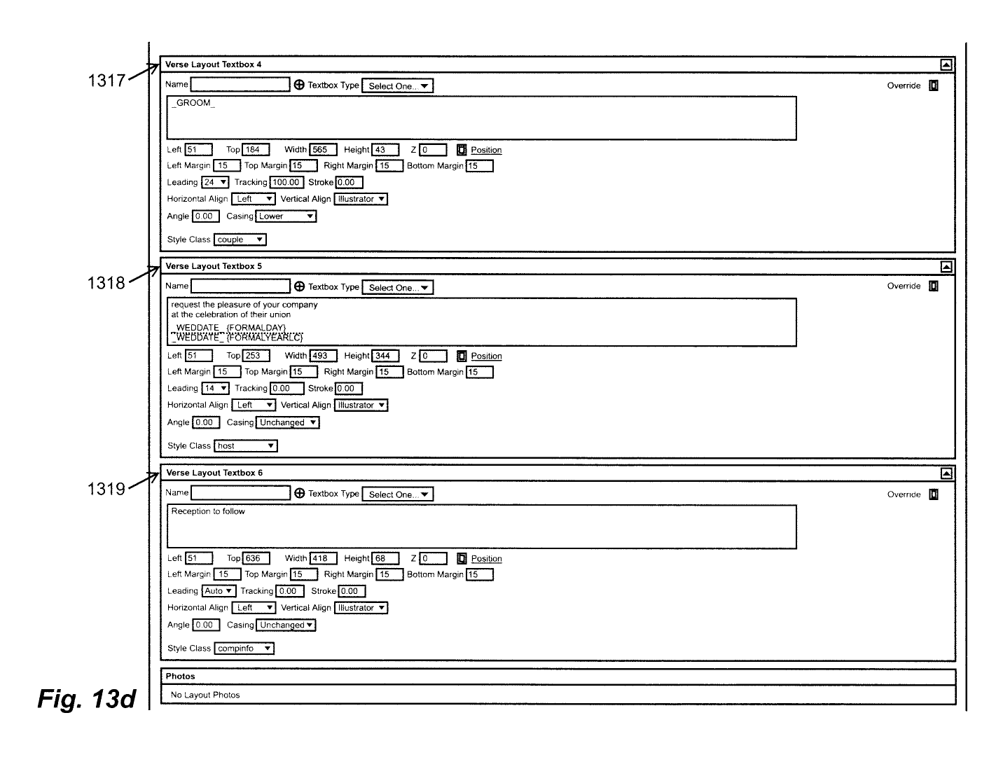

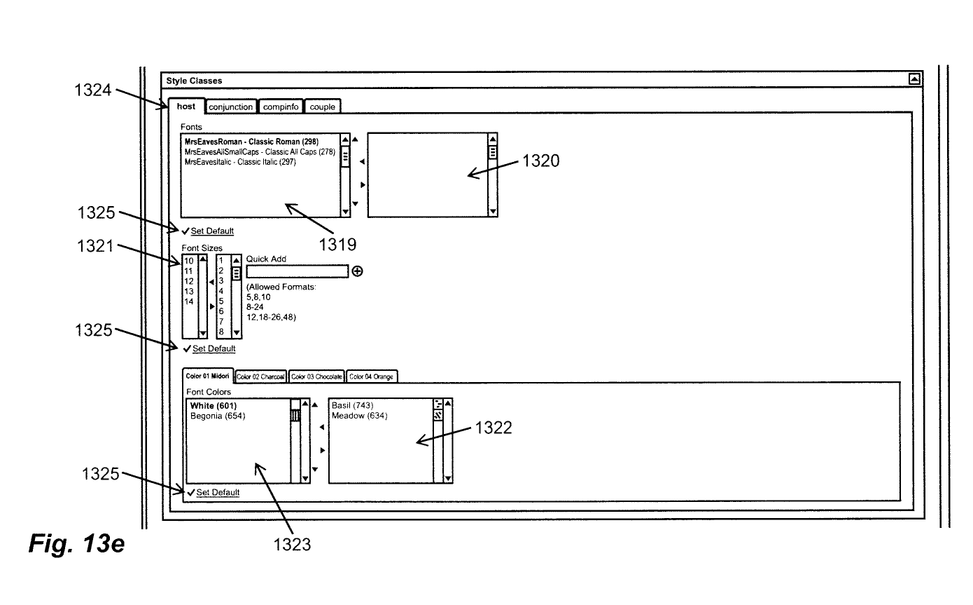

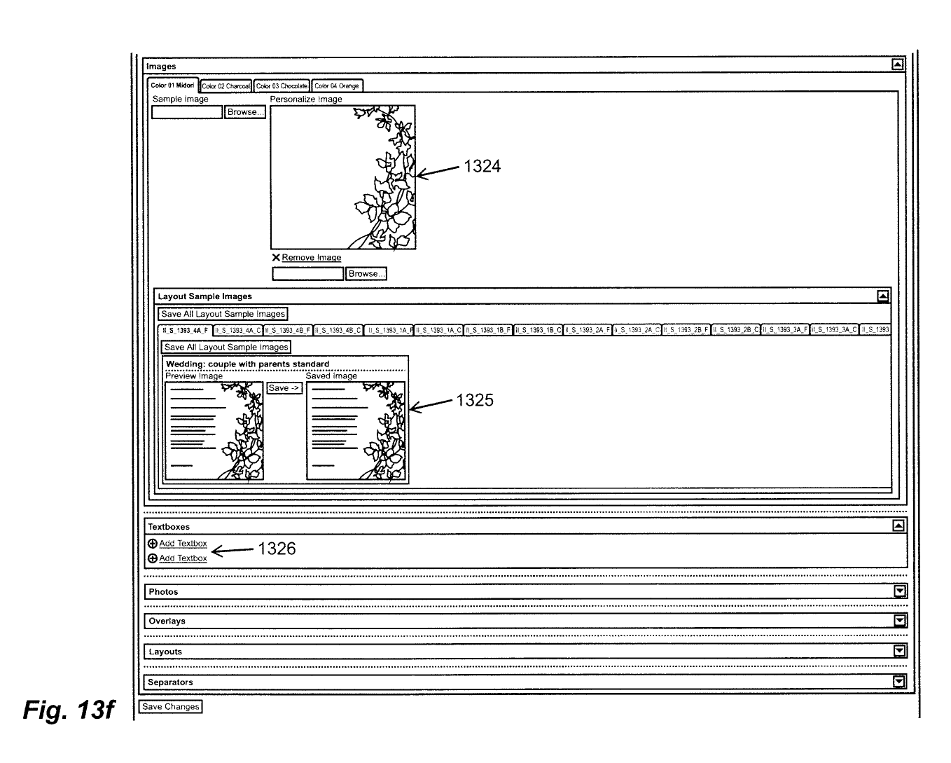

FIGS. 13a-f illustrate a product template wizard 240 for creating a product template using global template groups and layouts. As shown in FIG. 13a, a listing of all available template groups 1302 and a listing of selected template groups 1301 is provided. A template designer selects template groups from the listing of available groups 1302 (e.g., using a mouse or other cursor control device) and adds them to the listing of selected template groups 1301 to include the template groups in the product template. A number to the right of each template group indicates the number of global templates included within that template group. When a template group is selected, all the templates within that group are made available for the product template. In the specific example shown in FIGS. 13a-f, five template groups are selected: (1) Both Parents Hosting (containing two templates); (2) Bride's Parents Hosting (containing two templates); (3) Couple Hosting (containing five templates); (4) Couple With parents Hosting (containing four templates); and (5) Groom's Parents Hosting (containing three templates).

A listing of all available fonts 1304 and a listing of selected fonts 1303 is also provided. The designer selects fonts from the listing of available fonts 1304 to include them in the listing of selected fonts 1303 (e.g., via a mouse or other cursor control device). Similarly, a listing of available font colors 1306 and a listing of selected font colors 1305 are provided. Once selected, the fonts/colors are available for use in the product template.

A set of tabs 1307 are displayed to identify each of the global templates included in the product template (e.g., one tab per global template). As mentioned above, the global templates are included in the product template by selecting the template groups with which the global templates are associated (i.e., via selection boxes 1302, 1301). One particular tab (“Wedding: both parents standard”) is selected in FIG. 13a. Under the selected tab are a series of data entry fields 1308 containing the default values to be used in the product template. The default values are used when displaying a preview of the product template to the end user before the user has entered any personal information. Above each of the data entry fields is a name and associated variable code 1309. As mentioned above, the variable codes specified by the global template are used to hold the personal information entered by the end user. For example, the variable code “_BRIDE_” is used to hold the name of the bride as entered by the end user. The names positioned above the data entry fields (e.g., “bride's name”) are displayed within the Web pages to guide the end user during the data entry process (as described below).

As shown in FIG. 13b, a listing of selected layouts 1310 for the product template is also provided. The designer populates the listing 1310 by selecting from a listing of all available layouts 1311 (e.g., via a mouse or other cursor control device). In one embodiment, the layouts 1310 are automatically selected based on the template groups selected in FIG. 13a. For example, all layouts used in all templates within the template groups are added to the listing of selected layouts 1310. The template designer may then choose to add or remove layouts from the listing of available layouts 1310 as needed.

The layouts are visually displayed as a series of selectable tabs 1312 within the product template wizard. One particular tab is selected in FIG. 13b (layout “II_S_1393_4A_F,” previously shown in FIGS. 11a-c). The information contained in the layout is illustrated under the layout tab including a listing of textboxes 1314-1318 associated with the layout and the data contained in the textboxes. For each textbox, an override check box 1313 is provided, allowing the designer to override the default values of the textbox when selected. Consequently, the location of a particular textbox may be adjusted to avoid, for example, an image in the final product template.

As illustrated in FIG. 13e, separate tabs 1324 are provided within the product template wizard, one for each of the style classes 1108 a-f selected in each of the textboxes. Thus, in FIG. 13e, the tabs 1324 include “host,” “conjunction,” “compinfo,” and “couple.” A list of selected fonts 1319 and available fonts 1320 are provided directly under each tab. Once again, the user can move undesired fonts from list 1319 to list 1320 and can add desired fonts from list 1320 to list 1319. A modifiable list of font sizes 1321 is also provided as is a list of font colors 1323. Font sizes and colors may be added and removed from the listing of available sizes/colors (1321/1323) in the same manner as described above (e.g., font colors may be moved from the list of all font colors 1322 using a mouse or other cursor control device).

Default values for font, size and color may be set by selecting a “set default” link 1325, as illustrated, and the default values are highlighted (e.g., bolded) in their respective lists. In one embodiment, the default values are initially selected to display the stationery to the end user in the Web design interface. However, as described above, the user may choose different fonts, sizes and colors as long as they are included in each of the respective lists 1319, 1321, and 1323.

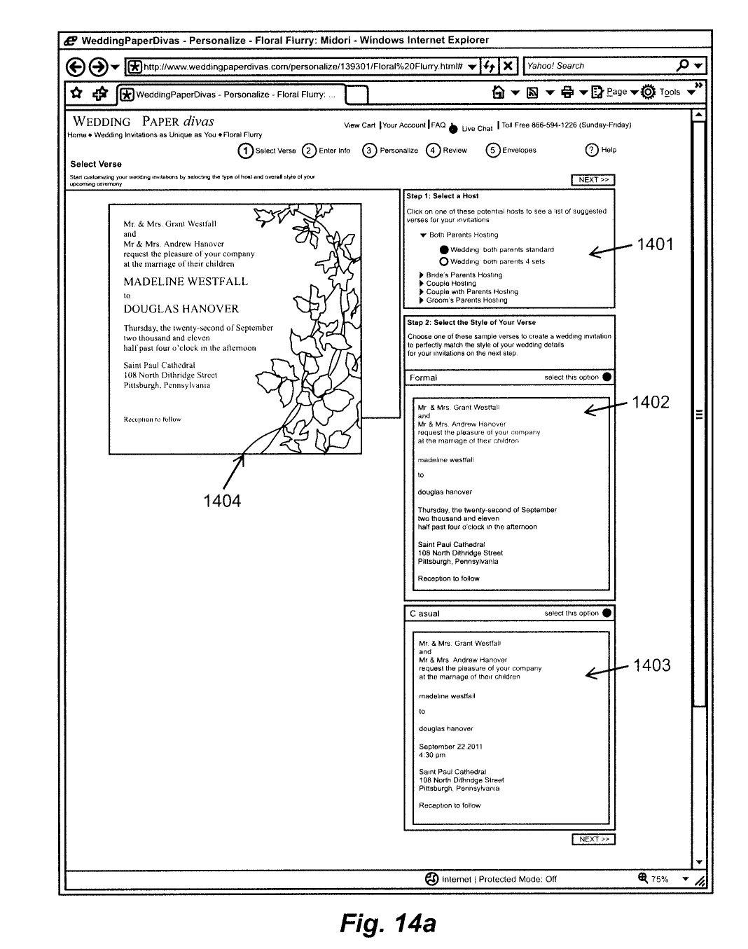

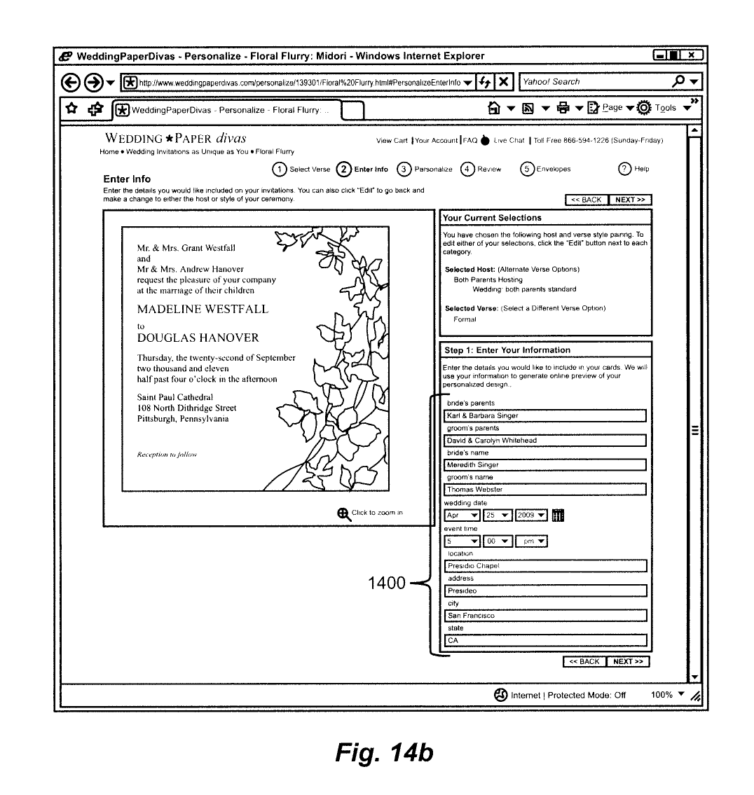

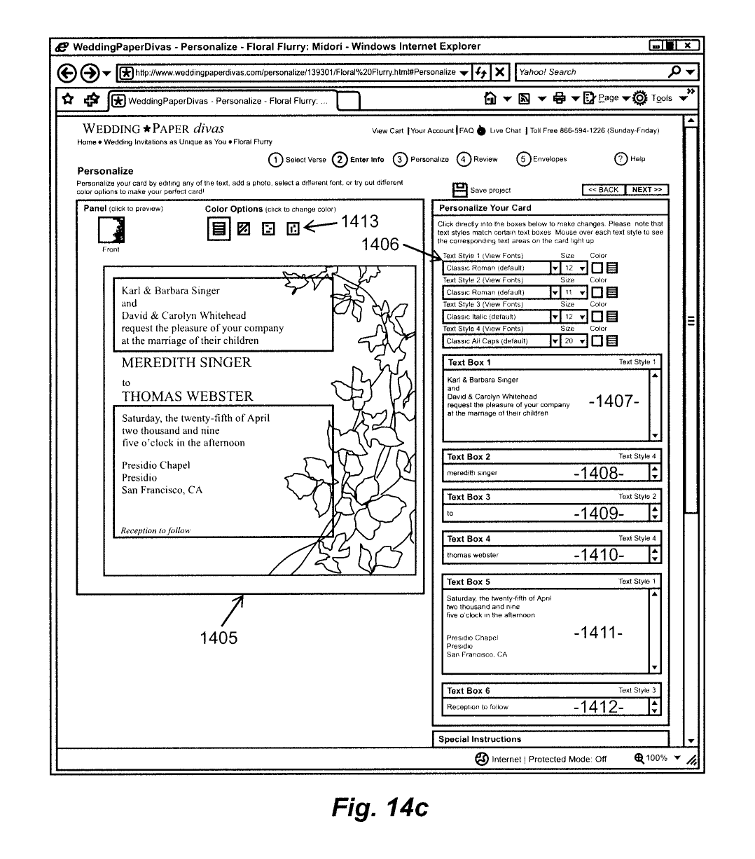

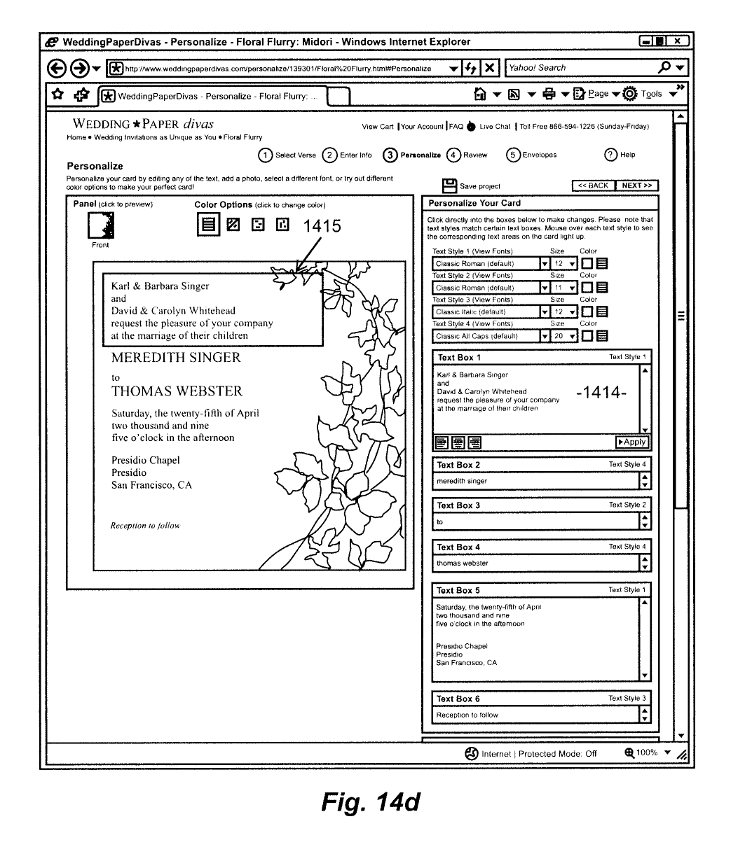

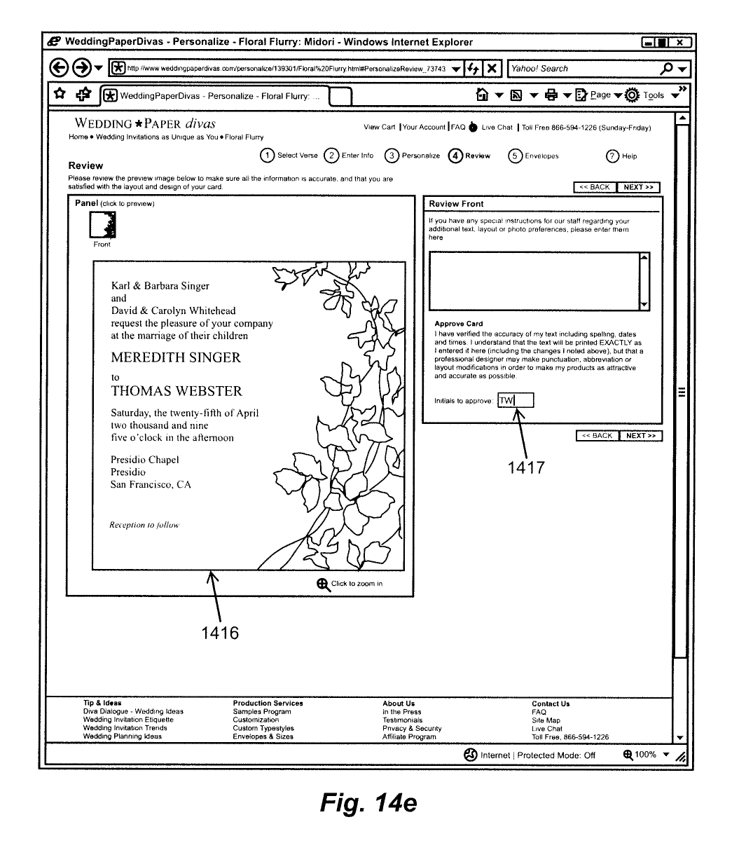

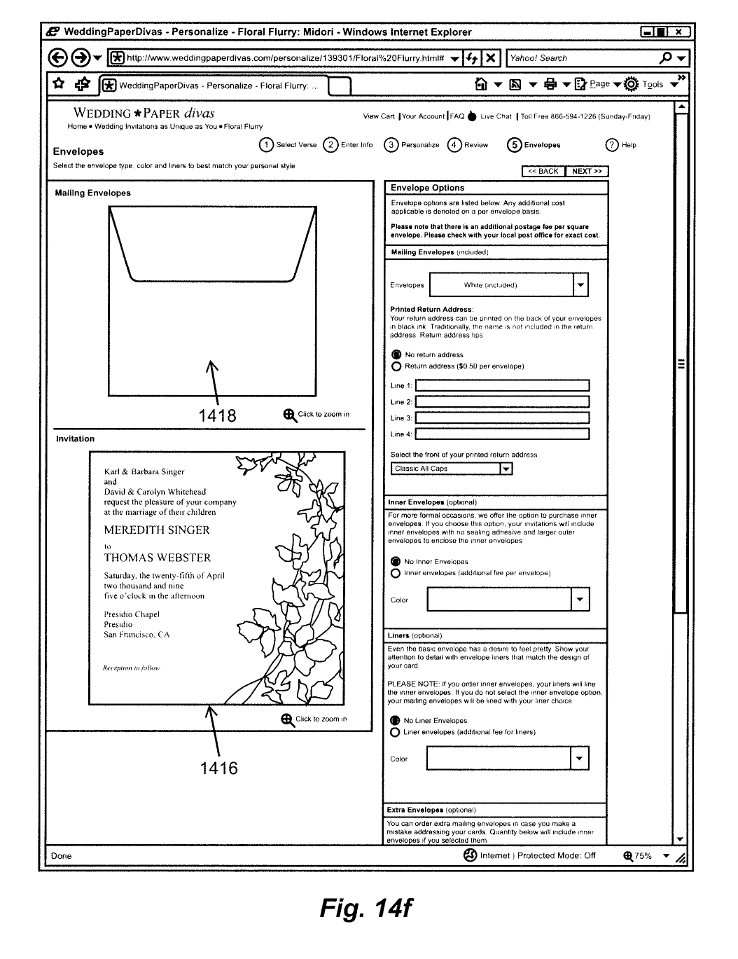

FIGS. 14a-e illustrate one embodiment of a Web-based graphical user interface (GUI) for designing stationery using the templates and layouts described above with respect to FIGS. 10a through 13f. After a user has selected a particular product template 220 the Web-based user data entry wizard 260 (FIG. 2) generates a sequence of Web pages such as those shown in FIGS. 14a-e to enable the user to create a personalized design 266.

Turning to FIG. 14a, in one embodiment, a preview image 1404 is generated which initially contains the default text included in the product template. As described above, the default text is entered by the template designer within data fields of the product template wizard (as shown in FIG. 13a). To the right of the preview image 1404 is a set of user-selectable template groups 1401 each containing one or more selectable templates. In the example shown in FIG. 13a, the template group “Both Parents Hosting” has been selected, thereby exposing two selectable templates: “Wedding: both parents standard” and “Wedding: both parents 4 sets.” In one embodiment, the template groups are implemented as hyperlinks which, when selected, expose the associated templates. Radio buttons are used for selecting the individual templates within a template group. However, various other types of selection elements may be used while still complying with the underlying principles of the invention.

Upon selection of one of the templates, different layout options for the selected template appears within regions 1402 and 1403 beneath the template groups 1401. The layout options 1402 and 1403 include the default text entered by the template designer within data fields of the product template wizard. Upon selection of one of the layouts 1402, 1403 (via a mouse or other cursor control device), the selected layout is highlighted and a preview image of the resulting stationery design is shown in preview region 1404. In the example shown in FIG. 14a, the “Formal” layout options is selected, resulting in a “Formal” layout displayed within the preview image 1404.

After a particular template and layout have been selected and the user selects a “next” button, the user is prompted to enter personal information in the user interface shown in FIG. 14b. In one embodiment, the data fields are generated based on the specific template and layout selected by the end user in FIG. 14a. For example, in FIG. 14b, data fields for names of both sets of parents, the bride and groom, the date, the time, and the location are provided to receive user data.

In one embodiment, after the user enters the requested information and selects the “next” button, the Web-based GUI illustrated in FIG. 14c is generated. The preview image 1405 is updated to include the personal information entered by the user and a listing of user-selectable style options 1406 is provided. The styles in the list 1406 represent all of the styles previously selected for each textbox in the template (see, e.g., FIGS. 11a-c which shows style class selections 1108). Upon selecting one of the styles from the list 1406, text box regions 1407-1412 which are assigned the selected style are highlighted, as are the corresponding text regions within the preview image 1405. In the example shown in FIG. 14c, “text style 1” has been selected, resulting in corresponding text boxes 1407 and 1411 being highlighted. The user may then modify the font, font size and color of the text associated with text style 1, thereby adjusting the text within the highlighted text boxes and within the preview image 1405. In the embodiment shown in FIG. 14c, drop down menus are provided to enable the user to modify the text styles using a predetermined range of acceptable values (see, e.g., FIG. 13e showing how the range is selected). Upon any changes to the text style or the text (as described below), the preview region 1405 is updated dynamically to reflect the changes.

In addition, as shown in FIG. 14c, a color region 1413 is provided to allow the user to select different color options for the stationery design. Once a new color option is selected, the preview region in 1405 is updated to reflect the new color.

In addition, as shown in FIG. 14d, the user may click on a text region 1415 of the preview image to cause the text box 1414 associated with that text region to become highlighted and to include one or more editing functions. Once the editing functions are enabled, the user may edit the text directly in the text box 1414, and may adjust paragraph formatting (e.g., left, right, center, justify, etc), as shown. An “Apply” button is provided to apply the changes to the selected text region 1415 of the preview image.

Once the text has been modified/accepted by the user, clicking on the “next” button causes the Web page shown in FIG. 14e to be generated which contains the final preview image 1416 of the design and a space for the initials 1417 of the user to approve the final design. Entering initials and clicking again on the “next” button causes the Web page in FIG. 14f to be generated, which provides the user an option for adding a return address to envelopes. The return address is then displayed on a preview image of the envelopes 1418.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, it will be readily apparent to those of skill in the art that the functional modules such as wizards and other logic may be implemented as software, hardware or any combination thereof. Accordingly, the scope and spirit of the invention should be judged in terms of the claims which follow.

What is claimed is:

1. A computer-implemented method for designing an online stationery template comprising:
defining a plurality of textboxes, each of the textboxes comprising text and/or variable codes, coordinate data defining textbox positioning, and a style class defining font, font size and/or font color;
defining a layout comprising specific textboxes from the plurality of textboxes;
defining a global template comprising one or more of the layouts;
extracting metadata from a file or other content provided by a stationery designer; and
generating a product template using information contained in the global template and the metadata extracted from the file.

2. The method as in claim 1 further comprising:
publishing the product template online, thereby making the product template accessible via a Web-based user interface.

3. The method as in claim 2 further comprising:
receiving data from a user related to the product template;
personalizing the product template with the data; and
sending the personalized product template to a printer and/or printing partner over a network.

4. The method as in claim 1 wherein the metadata comprises coordinate data, font data and color data associated with a plurality of text boxes and/or images contained in the file.

5. The method as in claim 4 wherein the file is an Adobe Illustrator (AI) file.

6. The method as in claim 1 wherein the global template comprises a series of questions to collect information from an end user, wherein values of the variables used in the global template are conditional based on answers to the series of questions.

7. The method as in claim 3 wherein the layouts specify how data entered by a user is to be formatted within the personalized product template.

8. A system having a memory for storing program code and a processor for processing the program code to generate a graphical user interface (GUI) for designing stationery comprising:
a template region for displaying a plurality of selectable templates to be used for a stationery design, the templates specifying variables and layouts for the stationery design, each of the templates selectable using a mouse or other cursor control device;
a layout region for displaying a plurality of selectable layouts associated with a template selected within the template region, each layout comprising an arrangement of text associated with the layout; and
a preview region for displaying a preview of the stationery, wherein the preview of the stationery is dynamically modified to correspond to the template and layout selected in the template region and layout region, respectively.

9. The system as in claim 8 wherein the layouts include a formal layout and a casual layout, the formal layout comprising an arrangement of text previously defined as “formal” and the casual layout comprises an arrangement of text previously defined as “casual.”

10. The system as in claim 8 wherein the GUI further comprises:
a plurality of data entry fields for receiving personalization data entered by the user, the data fields are generated based on the specific template and layout selected by the end user.

11. The system as in claim 10 wherein the preview region is dynamically updated to display the personalization data entered by the user.

12. The system as in claim 11 wherein the GUI further comprises:
a textbox region comprised of a plurality of textboxes, each of the textboxes comprising text displayed at different positions within the preview region, wherein some of the text comprises the personalization data entered by the user.

13. The system as in claim 12 wherein the GUI further comprises:
a style region comprised of a plurality of different text styles, each of the different text styles associated with one or more of the textboxes within the textbox region, the styles within the style region having a default option and a range of user-selectable options, wherein the user may select one or the user-selectable options with a mouse or other cursor control device.

14. The system as in claim 13 wherein the options comprise font, font size and font color.

15. The system as in claim 13 wherein, upon selection of a style within the style region, the textboxes associated with that style are highlighted.

16. The system as in claim 15 wherein upon selection of a user-selectable option associated with that style, the preview region is dynamically updated to reflect the selection of that option.

17. The system as in claim 12 wherein upon selection of text within the preview region, the textbox associated with that text enters into an edit mode in which the text within the textbox is editable by the user.

18. The system as in claim 17 wherein upon editing of the text by the user, the edited text is displayed within the preview region.

19. The system as in claim 18 further comprising:
providing one or more data entry fields for user entry of a return address; and
generating a second preview region comprised of an image of an envelope having the return address printed thereon.

20. A computer-implemented method for designing an online stationery template comprising:
defining a plurality of textboxes, each of the textboxes comprising text and/or variable codes, coordinate data defining textbox positioning, and a style class defining font, font size and/or font color;
defining a layout comprising specific textboxes from the plurality of textboxes;
defining a global template comprising one or more of the layouts;
generating a product template using information contained in the global template, the product template including a personalization region for displaying the textboxes within the layout, wherein generating the product template comprises calculating the position of each text box within the personalization region based on the size and position of the personalization area, the number of text boxes used in the layout, the number of lines of text in each text box, and the attributes of the text that determines the size of the text.

21. The method as in claim 20 wherein the attributes of the text that determines the size of the text includes font, size, leading, and tracking.

22. The method as in claim 20 wherein calculating the position of each text box comprises spacing each text box evenly within the personalization region.
